(19) United States
(12) Patent Application Publication
(10) Pub. No.: US 2010/0023372 A1
(43) Pub. Date: Jan. 28, 2010

(54) LINKED MOBILE BUSINESS AND ADVERTISING UNIT

(76) Inventor: Marcelo Morales Gonzalez, Garza Garcia, N.L. (MX)

Correspondence Address: MICHAEL WINFIELD GOLTRY, 4000 N. CENTRAL AVENUE, SUITE 1220, PHOENIX, AZ, 85012, US

(21) Appl. No.: 11/994,470

(22) PCT Filed: Sep. 22, 2005
(86) PCT No.: PCT/IB05/03005

§ 371 Date: Jan. 2, 2008

(51) Int. Cl. G06Q 30/00; G01C 21/00; G06Q 10/00; G06Q 50/00; G06Q 20/00; B60R 13/00; B62C 1/06

(52) U.S. Cl. 705/10; 701/300; 705/7; 705/14.37; 705/14.45; 705/14.61; 705/14.62; 705/14.63; 705/21; 705/28; 296/21; 296/26.01

(57) ABSTRACT

A linked mobile business and advertising unit that can sell products, services, and/or publicity. A plurality of units, together with a control unit, can form a chain. The control unit can sell time and space for the publicity devices controlled by the units. It can run publicity campaigns selecting geographical zones, market segments, times, and dates, while measuring the effect on sales. It can remotely turn on/off publicity devices. The control unit can suggest new locations, optimize inventory levels, and centralize customer information and transaction history. The units don't require foundation and can install/uninstall themselves rapidly, leaving no trace. The units are self-sufficient in services such as water, electricity, gas and drain; and, have flexibility to use these services when available. The units can transform themselves to ease transportation, to optimize operation or to protect against vandalism. The units can be configured as drive-thru, drive-in, or drive-inside.

### FIELD OF THE INVENTION

This invention relates to business units, which are mobile and linked, and which provide retail space for selling products and/or services, and which display publicity (e.g., advertising) on local or external devices. Such publicity may be controlled locally in the business unit or remotely from a control unit.

### BACKGROUND OF THE INVENTION

The linked mobile business and advertising units represent the next step in an evolution. This evolution started with the invention of cars. The arrival of cars to society has created new businesses and markets that have been evolving through time. The first step in this evolution started when Ford had succeeded producing high quantities of cars. There was already an urban reorganization. Roads for cars and different sidewalks for pedestrians appeared. Each one generating substantial traffic and thereby creating attractive markets. Businesses serving these outdoor moving customers appeared. There is a video giving a detailed explanation, and providing images, that describes this evolution. The name of this video is “Modern Marvels, Drive Thru”, from The History Channel A&E Television Network, written and produced by Barry Hill. The next paragraphs summarize nine evolutionary phases presented in this video.

Phase 1. Curbside gasoline pumps. These pumps eliminated the necessity of going to a store to buy gasoline in cans. In 1913, Gulf Corporation installed the first drive-in gasoline station in Pittsburgh, Pa. By 1916, in the US there were already 200 gasoline stations using this operation style. But drivers faced a disadvantage. Drivers had to get out of the car to visually make sure how much gasoline was being filled in their cars.

Phase 2. Stay in your car while buying. In 1920 gasoline stations started using a device named “Visi-gage pump”. This device allowed drivers to see, from their seats, the amount of gasoline pumped into their cars. And the main disadvantage of this phase was that businesses lacked large publicity signs visible from a long distance.

Phase 3. Integrating publicity. During this time, gasoline stations started using advertisements, and billboards, big enough to be seen from a distance by their potential customers, the drivers. In some cases, the store structure itself served as the advertisement. The book “California Crazy & Beyond”, authored by Jim Heimann, and published by Chronicle Books, shows descriptive pictures of these businesses that were designed with a strong publicity focus. The next big challenge was to use this service philosophy in food businesses.

Phase 4. Drive-in. By the end of the 1920's, in the United States alone there were already 8 million cars. Drivers created new habits, such as driving-out for lunch, and eating in their car. In the US, the first drive-in restaurant was the “Pig Stand” in Dallas, Tex. This drive-in was the first one to offer drivers a similar service given by drive-in gasoline stations. Drivers could stay comfortably in their cars while they ordered, paid, and picked-up their food. Either the cook, or the manager, walked out from the store to serve the driver. During the 1930's, in the United States, there was a big explosion of drive-in restaurants in the states of Texas, Florida, and California.

The book “The American Drive-In Restaurant”, authored by Michael Karl Witzel, and published by Motorbooks Classics, MBI Publishing Company, shows many pictures of these drive-in restaurants.

To give a better customer service, drive-in restaurants hired “car-hops”. These were young women and men who attended drivers. They were usually paid on a proportion of cars served, and since there was no rule for who goes first, they all ran after every car driving-in “hopping” to get it (hence thus the name “car-hop”). These young car-hops created an environment attractive for the youth, but started pushing away families and adults. Sadly, the problem at that time was that the youth didn't represent as much business as families and adults did.

Phase 5. Self-service drive-in. At the end of the 1940's, in San Bernardino, Calif., USA, Maurice and Richard McDonald redesigned their drive-in. An important change they made is that they avoided hiring car-hops. Now drivers had to get down from their cars and walked in the restaurant, where menus had only 9 products. These products were usually ready to take, so customers didn't wait as much as they used to. This self-service drive-in could serve an order in just 15 seconds. The McDonald brothers called this system the “Speedy Service System”. Families, adults, and youth as well, started using this system successfully.

During the 1950's other business people replicated this business model. Another neighbor from San Bernardino, Calif., named Glenn J. Bell Jr., who was a frequent customer to the McDonald's, started his own self-service drive-in, and we know it now as Taco Bell. Similarly, in 1953, Keith G. Kramer, from Daytona Beach, Fla., also visited McDonald's. He started Insta-Burger, a business we know today as Burger-King. At that time, the main problem all these businesses faced was finding a way to successfully replicate themselves in other geographical locations.

Phase 6. Franchising drive-in's. In 1954, Ray Kroc offered the McDonald brothers to buy the exclusive rights to franchise McDonald's. The first franchised store appeared in 1955. Five years later there were already 200 of them. During the 1960's, this industry amounted already to billions of dollars, and the main players were McDonald's, Burger King, Jack in the Box, Carl's Jr., and Kentucky Fried Chicken. At that point, the next challenge was to serve customers while they waited in their cars.

Phase 7. Drive-thru window. In 1969, Dave Thomas started Wendy's in Columbus, Ohio. He was the first to use a drive-thru window, also called a pick-up window, in a franchised drive-in. Five years later, 100 drive-ins had a pick-up window selling over $25 million dollars in fast food per year.

McDonald's resisted the pick-up window until 1975. That year in Sierra Vista, Ariz., a McDonald's franchisee decided to add a pick-up window to serve the soldiers who couldn't walk in the restaurant wearing a military uniform. Ten years after that, almost every McDonald's had a pick-up window. Burger King also started using pick-up windows in 1975. These pick-up windows created a new problem. Cars formed long lines waiting for their turn.

Phase 8. Enhancing customer service. Drive-thrus invested more in technology to speed-up service time, increase order-accuracy, clarify menu boards, and obtain better speaker clarity. For instance, in order to speed-up service time, the paying process was automated. Fast-food restaurants learned from toll-ways, which were the first to automate the payment process. Toll-ways used a wireless communication system, usually using radio frequency devices. One communication device was at the toll-way station, and the other one was inside the passing car. Toll-ways were able to charge directly to the driver's account. Fast-food restaurants also learned from gasoline stations which, in a different way, started automating the payment process creating self-service cashiers at the pump. These self-service cashiers accepted credit cards, debit cards, and special cards.

Phase 9. Proliferation. We now see drive-thrus not only in gasoline stations, fast-food restaurants, and toll-ways, but also in banks, car-wash stations, vaccination centers, wedding services, laundries, post-offices, voting centers, taxes stations, and even in funerals services, and churches.

Current problems and obstacles:

Presently, businesses, either chains or single owners, servicing drivers, people in vehicles, and/or pedestrians, haven't been able to evolve to a next phase because they face some or all of the following problems:
(a) Ineffective use of communications and information. Each one of these business units has its own universe of information that is not widely shared with other business units. There is a lack of synergy. For instance, one business unit might have a transaction history and an established credit with one customer, while other ones won't have any background about the same customer.
(b) Little exploitation of publicity. These business units usually don't take advantage of their publicity potential. Once they have a good position to show publicity, they should profit from it. Additionally, they don't have remotely controlled publicity to speed-up the execution of a publicity campaign, and to reduce the associated costs of installing and uninstalling ads.
(c) No feedback on publicity and promotions. Even when these business units display publicity, or promote products, these business units struggle to measure the results of a locally or remotely controlled marketing campaign.
(d) Expensive energy consuming advertising devices. Some publicity devices from these business units consume so much energy that they should operate only a limited time per day. If employees are not present to control these publicity devices, these devices are controlled with a timer, or aren't used at all. This is a problem for chains that need the flexibility to sell publicity remotely controlled in a variable schedule in different business units.
(e) Non-customized customer attention. These business units are usually dependent on employees for customer recognition. Employee turnover has an impact in customer loyalty. And, even in those business units where the customer has a warm contact with longtime employees, when the same customer buys at another unit from the same chain, usually that customer is unknown.
(f) Long waiting lines. Many customers flee away from slow business units. One of the most common problems these business units face is a slow paying process at the cashier. A single customer should be able to go to different business units in different locations and experience a similar serving time. Additionally, in order to increase speed, a customer should be able to be charged directly to a pre-established account, and that account should be the same for the same customer at all the business units of the same chain.
(g) High administrative costs. Indirect costs occupy an important proportion of costs in these business units, and these indirect costs take away much of the margin. These indirect costs should be absorbed and prorated by many business units to ease their burden.
(h) High manufacturing costs. Many of these business units are manufactured only once the same way. There is no learning curve, and no economies of scale.
(i) Time consuming and expensive permits. Many of these business units require city and state permits. This is part of a tiring and long process to comply with regulations.
(j) Difficult employee attraction and retention. These business units' employees usually have only few hours of peak operation per day, having plenty of time the rest of the day. The non-hard working hours should be used productively in activities such as education and training. It would be easier to attract and retain employees this way.
(k) Risk associated to anchor a business unit to one site. Many successful businesses go out of operation when government changes zoning rules, or someone decides to build a construction nearby affecting traffic for several months, or even years. Other businesses that are just starting and have already invested in installation costs, might see the need to move themselves to another site after a short time, losing a lot of money. Thus, a need exists to have businesses with the flexibility to move.
(l) Difficulty to rapidly approach temporary traffic. There is temporary heavy traffic that could produce high sales volumes for a short time. For instance, an event in a stadium might justify several business units to be around for several hours, but no more than that. Or a spring-break vacation period might have increased traffic in some places that usually wouldn't justify a permanent business installation. Therefore, a need exists to have businesses with the flexibility to rapidly install and uninstall themselves.
(m) Seasonal products. Even in places when there is constant heavy traffic, there are seasonal products that will sell only in specific months. These short yearly sales won't justify businesses to own constructions that are not operating for entire months during the year. But at the same time, these high seasonal sales justify their presence those months. Thus, a need exists to have mobile businesses with the flexibility to install themselves only during specific months of the year.
(n) Lack of infrastructure and services in many sites close to heavy traffic. Usually, developed sites next to heavy traffic areas are expensive due to high demand. These sites are so expensive, that in some cases, only high-margin businesses can afford them. In contrast, there are many great sites that businesses can't use because they lack infrastructure, such as foundation, or construction; and they lack services, such as water, electricity, and drain. Some examples of these sites are unused space in gasoline stations, car washes, parking lots, and empty land. Landlords are usually reluctant to lease these lands because they want to keep them clean and intact for future use. Consequently, a need exists for self-sufficiency in infrastructure and services, to let business units install themselves in any available place, with the ability to rapidly move to another location leaving no trace.
(o) Lack of flexibility to use any existing combination of services. Attractive sites for these business units may have some services such as water, drain, and electricity, while they lack others. These business units usually lack the hybrid ability to procure the lacking resources and services.
(p) Restriction in dimensions. On the one hand, mobile units need to be small to be transported from site to site. Different countries have different laws regulating their standards for towing, or moving mobile structures on public roads. Even in the same country, different states or cities may use different regulations. On the other hand, in order to operate, businesses usually require larger dimensions. Some times regulations, such as the Americans With Disabilities Act, require businesses to ensure that handicapped employees are provided with a proper work environment. Therefore, a need exists for business units with the ability to vary their dimensions.
(q) Vandalism and security. Drive-thru businesses are frequent victims of vandalism. Vandalism has a negative effect in profits, and scares employees.

Prior Art

There have been several attempts to solve some of these problems, but no one has successfully integrally solved all of them. The following is a brief summary of the prior art related to these efforts.

International PCT patent WO 03/080964, also filed as U.S. Pat. No. 6,722,474 to Hatzor, from Israel (2004), discloses a “Smart Service Cart”. The Hatzor '474 patent (“Hatzor”), which is hereby incorporated by reference herein in its entirety, has several perceived disadvantages.

First, Hatzor calls for the “Smart Service Cart” to be controlled by a computer, and while the computer could be local, the Hatzor '474 patent places an emphasis on remote control of operations. Hatzor describes unmanned “Smart Service Carts”, and even when Hatzor accepts manned “Smart Service Carts” the operation would still have to be computer controlled.

Second, Hatzor neither claims, nor discloses with an explained figure, remotely controlled advertising. Hatzor claims only remote control for operation, and does not claim remote control for advertising.

Third, Hatzor forces the “Smart Service Cart” to have a computer-controlled environmental unit. FIG. 5 in Hatzor shows, as an example, an air conditioning machine. While this is excellent for certain applications, in general it is too rigid and expensive for many mobile businesses that don't even need air conditioning, much less an environment controlled by a local, or remote, computer.

Fourth, Hatzor describes the “Smart Service Cart” as having a substantial spherical shape. Hatzor is not describing in its specifications or drawings, nor doesn't claim, other shapes that are more efficient in space use.

Fifth, Hatzor describes a “Smart Service Cart” that can't be rapidly installed and uninstalled, and it doesn't have its own wheels to be moved. The “Smart Service Cart” requires the use of a crane to be placed on a boom-truck, or a tow platform for relocation.

Sixth, Hatzor doesn't claim, and doesn't show in its drawings, the ability of the “Smart Service Cart” to be self-sufficient in water, and energy services in order to be installed in a place lacking these services.

Seventh, Hatzor doesn't claim varying the dimensions of the “Smart Service Cart”. While it has parts that move outward, and doors that open, the dimensions of the basic structure of the “Smart Service Cart” are the same. This restriction limits the space of the “Smart Service Cart” to the maximum dimensions permitted by the laws regulating the transportation, or the operation, of these units.

Eighth, even when Hatzor's “Smart Service Cart” has a billing unit, it only relies only on credit cards, smart cards, member cards, and cash. It doesn't charge automatically to a recognized customer account without any card approval process.

Ninth, Hatzor forces the “Smart Service Cart” to focus on food. This patent doesn't cover other lines of business.

U.S. Pat. No. 5,727,352 to Maurice Bared et al (1998) (“Bared”) discloses a “Prefabricated, Transportable, Drive-Thru Convenience Store”. The Bared '352 patent (“Bared”), which is hereby incorporated by reference herein in its entirety, has several perceived disadvantages.

First, Bared strictly requires a walk-in cooler. Many other drive-thru businesses exist and operate successfully without the restriction of a walk-in cooler. Second, Bared doesn't have remotely or locally controlled publicity displays. Third, Bared discloses a convenience store that is built in one place, and installed in another one for a good time. The process of uninstalling, moving, and reinstalling is slow, expensive, and requires infrastructure, such as foundation. Fourth, Bared isn't self sufficient in services such as water, drain, and electricity. This complicates the process of good, available, and affordable sites. Fifth, Bared can't expand and retract the convenience store in an easy way varying its dimensions, and maintaining its unity as a whole. This complicates even further the moving process. Sixth, Bared isn't linked to a control unit controlling attributes, such as geographical positions to avoid zone saturation, publicity displayed, promotions to push a specific products, inventory levels to ensure product availability, a customer's credit or debit account to ease customer's transactions in all business units, and a history of operations and transactions.

U.S. Pat. No. 5,367,452 to Gallery et al (1994) discloses a “Mobile Management System for Transportable Business Operations”. The Gallery '452 patent (“Gallery”), which is hereby incorporated by reference herein in its entirety, has several perceived disadvantages.

First, Gallery discloses only a system, and not a method, nor a physical device, or unit.

Second, Gallery's system doesn't control publicity remotely. It doesn't manage publicity campaigns on the mobile business units. In contrast, it only manages a small display that is aimed only to inform customers about product pricing, and transaction information.

Third, Gallery's system strictly requires the inclusion of personnel management in its control, as described in its claims. This is too rigid, and forces the system to do an operation that is not necessarily required in environments where personnel management is not such an important issue.

Fourth, Gallery's system requires the use of a page controller, as described in its claims. This was intended to page the owner if the system sensed that anyone was moving the cart during non-operation hours. This movement is interpreted as an act of vandalism. This feature forces the system to do an operation that is not necessarily required.

There are two patents for showing remotely controlled publicity on mobile devices. These are U.S. Pat. No. 6,236,330 to Cohen (2001), and U.S. Pat. No. 6,701,143 to Dukach (2004). These patents have several perceived disadvantages. First, their systems and/or methods are for display-devices that are moving while they show publicity, and as such, these displays are designed to be mounted on taxis, or vehicles that are constantly moving. These patents are not intended for business units that are parked while they are in operation. Second, these patents are just systems and/or methods, they don't include mobile business units with drive-thru windows selling products or services, they don't include mobile business units that are expansible, retractable, and self sufficient in water, drain, and energy services. Third, while these patents mention display devices that are linked to a control unit, the control unit doesn't control attributes, such inventory levels to ensure product availability, a customer's credit or debit account to ease customer's transactions in all business units, and a history of operations and transactions.

There is another patent for geographic-based advertising for mobile users, U.S. Pat. No. 6,542,498 to Stewart (2002). This patent has several perceived disadvantages. First, it only targets mobile users who carry with them portable smart devices, such as notebooks, personal computers, and Personal Digital Assistants (PDA's). Thus, only the people carrying these devices see the ad. This patent doesn't target car drivers or pedestrians moving independently and apart from the display device. Second, messages are sent through a known array of fixed network access points that are located in places such as airports, and cafes. Thus, only people subscribed to this wireless service can receive these messages. Third, this patent doesn't claim any mobile business unit.

There are several patents for remotely controlled publicity. These are WO 02/35370 to Lee (2002), U.S. Pat. No. 6,430,603 to Hunter (2002), U.S. Pat. No. 6,401,075 to Mason (2002), and U.S. Pat. No. 5,995,015 to DeTemple et al (1999). But all these patents don't consider mobile business units that can sell products or services.

There are several patents for mobile advertising, having the same limitations mentioned in the patents showing publicity on mobile devices (Cohen and Dukach), additionally, they aren't linked to a control unit, and they are not business units selling products. Some examples are: U.S. Pat. No. 6,598,327 to Strzeletz (2003), U.S. Pat. No. 6,585,305 to Nazginov (2003), U.S. Pat. No. 6,513,052 to Binder (2003), U.S. Pat. No. 6,145,230 to Holmberg (2000), U.S. Pat. No. 6,036,250 to Glatter (2000), U.S. Pat. No. 5,918,924 to Cowan (1999), U.S. Pat. No. 5,657,566 to Key (1997), U.S. Pat. No. 5,507,109 to Rinzler (1996), U.S. Pat. No. 5,263,756 to Gaspar, and U.S. Pat. No. 5,083,826 to McCrary (1992).

There is a patent for a system and method for remote merchandising. This is Canadian Patent CA 2,316,009 to Amiri (2000). The Amiri '009 patent (“Amiri”), which is hereby incorporated by reference herein in its entirety, has several perceived disadvantages.

First, Amiri discloses a system and method where service centers act only as show rooms, but they don't have products in stock ready to sell. In these service centers, customers can find product samples to feel, touch, and see the product before buying it. But, if the customer actually wants to buy the product, it has to be ordered to the supplier, and the customer has to pick-up the product at the service center when it arrives.

Second, Amiri requires a service center installed in a facility that can't be mobile. It can't be mobile because it is the address where suppliers ship all the products that customers buy. Amiri aims to reduce shipping costs by eliminating individual packaging, thus Amiri requires service centers to be located in a fixed location. Also, Amiri offers assembly services in their service centers. All these elements give us an idea of the size of the service center. It should be large enough to have it fixed in a specific location.

Third, Amiri doesn't display locally or remote controlled advertising on service centers according to their geographical zone, or other characteristics. Also, since the service centers are fixed in one location, there is no way to run publicity campaigns over dynamic points that can move from one day to another.

There is a patent to turn-on and off electrical apparatuses remotely. This is U.S. Pat. No. 5,898,384 to Alt et al (1999). However this patent doesn't mention that the purpose of its apparatuses is to display publicity. Additionally, this patent doesn't claim any linked mobile business units.

There are several patents for customer recognition. Some examples are U.S. Pat. No. 6,513,015 to Ogasawara (2003), and U.S. Pat. No. 6,183,362 to Bushy (2001). There are also patents related to identifying a customer through the recognition of the license plates of the customer's car. Some examples are U.S. Pat. No. 6,553,131 to Neubauer et al (2003), U.S. Pat. No. 6,473,517 to Tyan (2002), and U.S. Pat. No. 5,315,664 to Kumagai (1994). None of these patents work as an integrated part of mobile business units linked to at least one control unit where the information recognized is stored to be used by other business units.

There are several patents for automatically charging a customer account passing through a toll station. Some examples are U.S. Pat. No. 6,337,639 to Kojima (2002), and U.S. Pat. No. 4,963,723 to Masada (1990). None of these patents charge goods selected by the user, they just charge a fee for passing through a toll-road. These patents are not integrated to mobile business units that are linked to a control unit, and that sell products and/or services.

Additionally, there are several patents for food service kiosks, mobile kitchens, mobile catering units, food carts, and mobile beverage stations. Some examples are U.S. Pat. No. 6,189,944 to Piche (2001), U.S. Pat. No. 5,938,261 to Faba (1999), U.S. Pat. No. 4,971,377 to Aquilante (1990), U.S. Pat. No. 4,359,073 to Stoutz (1982), Japanese Patent Application 60-130761 to Maruyama (1985), U.S. Pat. No. 4,270,319 to Spasojevic (1981), U.S. Pat. No. 3,778,099 to Rogove (1973), U.S. Pat. No. 3,544,152 to Low (1970), U.S. Pat. No. 3,191,400 to Swenson (1965), U.S. Pat. No. 2,982,578 to Lowe (1961), U.S. Pat. No. 2,767,013 to Spears (1956), U.S. Pat. No. 2,733,094 to Carlton (1956), French Patent 1,014,110 (1952), U.S. Pat. No. 1,327,248 to Moody (1920); and U.S. Pat. No. 489,893 to Buckley (1893). None of these patents have publicity displays to show advertising that is controlled locally or remotely. None of these patents show businesses linked to a control unit controlling attributes, such as geographical positions to avoid zone saturation, promotions to push specific products, inventory levels to ensure product availability, a customer's credit account to ease customer's transactions in all business units, and a history of operations and transactions. This mentioned prior art does not provide speed paying, training space for employees, self-sufficiency in services, or flexible, expandable, and retractable structures that communicate to at least one control unit.

There are many patents for expansible trailers. Some examples are Dutch Patent DE 4,321,271 to Walter (1995), European Patent Application 0,009,945 to Efde (1980), U.S. Pat. No. 3,866,365 to Honigman (1975), U.S. Pat. No. 3,534,997 to Mitchell (1970), U.S. Pat. No. 3,397,908 to Flajole (1968), U.S. Pat. No. 3,070,850 to McClure (1963), U.S. Pat. No. 2,822,212 to Frey (1958), French Patent 1,070,557 to Blanchet (1954), U.S. Pat. No. 2,167,557 to Stout (1939), and British Patent GB 418,915 to Wiltshire (1934). All these patents show solutions of units that are not linked to a control unit controlling attributes, such as geographical positions to avoid zone saturation, publicity displayed, promotions to push specific products, inventory levels to ensure product availability, a customer's credit or debit account to ease customer's transactions in all business units, and a history of operations and transactions. Additionally, none of these patents are business units providing drive-thru operation.

There are several patents for portable toilets, management of gray water, and used-water in trailers. Some examples are U.S. Pat. No. 5,301,376 to Herbert (1994), U.S. Pat. No. 4,974,899 to Sargent (1990), U.S. Pat. No. 4,957,323 to Johnson (1990), U.S. Pat. No. 4,776,631 to Sargent et al (1988), U.S. Pat. No. 4,641,383 to Sargent et al (1987), U.S. Pat. No. 4,621,380 to McGill (1986), U.S. Pat. No. 4,527,295 to Lacore (1985), U.S. Pat. No. 4,306,321 to Norlin (1981), U.S. Pat. No. 4,217,668 to Sargent et al (1980), U.S. Pat. No. 3,801,991 to Fulton et al (1974), U.S. Pat. No. 3,094,707 to Fleming (1963), and U.S. Pat. No. 1,514,157 to Harding (1924). All these patents share the same perceived disadvantages

None of these portable toilet patents allow a toilet inside of a trailer to store its gray water in a tank with the option to remove the tank full of gray water from outside the trailer, and to replace the tank by an empty one, from outside the trailer. These patents don't have the option to connect directly to a drain service. None of these patents are integrated in a mobile business unit that is linked to a control unit.

While there have been several attempts to solve some of the problems listed above, no one has successfully integrally solved all of them. This is why I introduce my invention, to solve all the listed problems. The next paragraphs describe the object of the invention.

### OBJECT OF THE INVENTION

Several objects and advantages of the present invention are:
(a) to provide a linked mobile business and advertising unit that has a communication link to at least one control unit, enabling a plurality of these business units to consolidate themselves in a chain, where the control unit has an information system that can control several attributes of the chain of business units, such as their geographical positions to avoid zone saturation, inventory levels to ensure product availability, a customer's account to ease customer's transactions in all business units, display of publicity to manage remotely-controlled publicity campaigns, a history of operations and transactions, and where the control unit can provide administrative and information services to the linked mobile business and advertising units;
(b) to provide a linked mobile business and advertising unit that complements the income it obtains from selling products and/or services with the income from selling publicity, where this publicity can be either controlled remotely or locally, and where the publicity can be displayed only on certain units which can be chosen by geographical zone, market segment, calendar, and/or time;
(c) to provide a linked mobile business and advertising unit that can measure the effect on sales of remotely controlled publicity, and that is able to classify such information by market segment, geographical zone, calendar, and time;
(d) to provide a linked mobile business and advertising unit that can turn on and off its publicity display devices remotely from a control unit to make an efficient use of energy, and to enable publicity campaigns with last minute changes to take advantage of these publicity display devices even when the linked mobile business and advertising unit isn't operating or when no operators are attending the unit;
(e) to provide a linked mobile business and advertising unit that detects the arrival of a customer, recognizes any established customer of the chain even when the customer has never bought anything in this specific unit, knows the customer's preferences, has the customer's history, displays customized publicity for the customer, and gives customized promotions to the customer;
(f) to provide a linked mobile business and advertising unit that can speed a cashier's waiting line by charging directly to a customer's account the products and/or services acquired without any bank approval process, where the customer's account is the same in a chain formed by a plurality of these linked mobile business and advertising units, and in any random location where these linked mobile business and advertising units operate;
(g) to provide a linked mobile business and advertising unit that can reduce many of its indirect costs by sharing these costs with other linked mobile business and advertising units, even when the other linked mobile business and advertising units are not necessarily selling the same products and/or services, and not necessarily part of the same corporation, company, franchise, or brand;
(h) to provide a linked mobile business and advertising unit that will be inexpensive to produce as a consequence of economies of scale, due to a large volume of similar manufactured units;
(i) to provide a linked mobile business and advertising unit that will allow having several permits prearranged, such as health, safety, and transportation permits, as a consequence of manufacturing similar models in large quantities;
(j) to provide a linked mobile business and advertising unit that provides inside of it training space and technology, so that employees working there can use non-operating time studying using a virtual university system, a distance learning model, a self didactic model, or any other current learning model; this advantage will attract and retain employees who can pursue a degree while they work;
(k) to provide a linked mobile business and advertising unit that its mobility reduces the risk associated to anchoring itself to one site;
(l) to provide a linked mobile business and advertising unit that rapidly installs and uninstalls, enabling it to approach temporary traffic such as events in stadiums, or to adapt to sudden changes in road traffic;
(m) to provide a linked mobile business and advertising unit that can be installed in one site for several months selling seasonal products and/or services, and then be easily uninstalled and moved or used for other products and/or services;
(n) to provide a linked mobile business and advertising unit that is self-sufficient in services such as water, drain, electricity, and energy, not requiring infrastructure such as foundation, and with the flexibility to use all these if they exist, thus being able to take advantage of many locations that otherwise couldn't be used, and being able to attract many landlords who are willing to lease their land to businesses that can move out rapidly leaving the used land intact;
(o) to provide a linked mobile business and advertising unit that has the flexibility to be self-sufficient in services such as water, electricity, gas, energy and drain, and with the ability to use these services if they exist, measuring their consumption; this ability will allow this business unit to acquire not only large amounts of these resources, but also, small amounts needed on the go, from small suppliers;
(p) to provide a linked mobile business and advertising unit that can vary its dimensions to comply with laws regulating transportation of mobile units on public roads, and to maximize its space while parked and in operation; this business unit has the option of performing this variation of dimensions so easily that in few minutes a single handicapped person can do it; and
(q) to provide a linked mobile business and advertising unit that can protect itself from vandalism, either when it's in operation or when it's not operating, enabling this business unit to operate at unprotected sites.

Still further objects and advantages will become apparent from a consideration of the ensuing description and drawings.

### SUMMARY OF THE INVENTION

A linked mobile business and advertising unit that can sell products, services, and/or publicity. A plurality of units, together with a control unit, can form a chain. The control unit can sell time and space for the publicity devices controlled by the units. These publicity devices can be located locally or at a distance from the linked mobile business and advertising unit, and close to customer traffic. The control unit can run publicity campaigns selecting geographical zones, market segments, times, and dates, while measuring the effect on sales. It can remotely turn on/off publicity devices. The control unit can suggest new locations, optimize inventory levels, and centralize customer information and transaction history. The units don't require foundation and can install and uninstall themselves rapidly, leaving no trace. The linked mobile business and advertising units are self-sufficient in services such as water, electricity, gas and drain; and, have the flexibility to use these services when available. The units can transform themselves to ease transportation, to optimize operation or to protect against vandalism. The units can be configured as a drive-thru, drive-in, or drive-inside.

### BRIEF DESCRIPTION OF THE DRAWINGS

In the drawings, closely related figures have the same number but different alphabetic suffixes.

FIG. 1 is diagram showing a chain of mobile business units that are linked to at least one control unit.

FIG. 2 is a diagram showing subchains of linked mobile business and advertising units spread in different geographical areas.

FIG. 3 is a perspective view showing the front, top, and right sides of the preferred embodiment of the linked mobile business and advertising unit when expanded, parked, and in operation.

FIG. 4 is a perspective view showing the preferred embodiment of the linked mobile business and advertising unit using a mobile display device.

FIG. 5 is a perspective view showing the front, top, and right sides of the preferred embodiment of the linked mobile business and advertising unit when in the process of expanding.

FIG. 6 is a perspective view showing the front, top, and right sides of the preferred embodiment of the linked mobile business and advertising unit when is non-operational, parked and secured.

FIG. 7 is a perspective view showing the front, top, and right sides of the preferred embodiment of the linked mobile business and advertising unit when retracted and ready to move.

FIG. 8-A is an upper view showing the preferred embodiment of the linked mobile business and advertising unit when expanded, parked, and in operation.

FIG. 8-B is a frontal view showing the preferred embodiment of the linked mobile business and advertising unit when expanded, parked, and in operation.

FIG. 9 is a perspective view showing the front, top, and right sides of the preferred embodiment of the linked mobile business and advertising unit when it's non-operational, parked and secured, and clarifying the connections to the exterior for services such as water, electricity, gas and the sewer tank.

FIG. 10 is a perspective view showing the front, top, and right side views of an alternative embodiment of the linked mobile business and advertising unit when expanded, parked, and in operation. This is a “drive-inside” alternative.

FIG. 11 is a right side view of the “drive-inside” alternative embodiment of the linked mobile business and advertising unit showing when is in the process of expanding.

FIG. 12-A is a cross-section view showing the right side of the preferred embodiment of the linked mobile business and advertising unit when non-operational, parked and secured, using a vertical telescopic retraction.

FIG. 12-B is a cross-section view showing the right side of the preferred embodiment of the linked mobile business and advertising unit when operational using a vertical telescopic expansion.

FIG. 13-A is a cross-section view showing the right side of an alternative embodiment of the linked mobile business and advertising unit when non-operational, parked, and secured, using a vertical accordion retraction.

FIG. 13-B is a cross-section view showing the right side of an alternative embodiment of the linked mobile business and advertising unit when operational, using a vertical accordion expansion.

FIG. 14-A is a cross-section view showing the right side of an alternative embodiment of the linked mobile business and advertising unit when non-operational, parked and secured, using a horizontal telescopic retraction.

FIG. 14-B is a cross-section view showing the right side of an alternative embodiment of the linked mobile business and advertising unit when operational using a horizontal telescopic expansion.

FIG. 15 is a schematic diagram showing the reception, storage, and consumption of clean water.

FIG. 16 is a schematic diagram showing the reception, storage, and consumption of electricity.

FIG. 17 is a schematic diagram showing the reception, storage, and consumption of gas.

FIG. 18 is a schematic diagram showing the sewer tank, and also showing gray water handling.

FIG. 19 is a block diagram illustrating the method for operating the linked mobile business and advertising unit.

FIG. 20 is a block diagram illustrating the method for operating the chain of linked mobile business and advertising units.

### REFERENCE NUMERALS FOR DRAWINGS

110 Linked mobile business and advertising unit
120 Control unit
140 Communications link from the linked mobile business and advertising unit to the control unit
142 Communications link from the control unit to the publicity clients that want to display their publicity
143 Communications link from the control unit to the manufacturer, producer or wholesaler of the goods sold in the linked mobile business and advertising units
146 Publicity clients that want to display their ads on the linked mobile business and advertising units
147 Manufacturer, producer or wholesaler of the goods sold in the linked mobile business and advertising units
150 Geographical zone
155 Subchain of linked mobile business and advertising units
158 Chain of linked mobile business and advertising units
160 Body carriage
165 Body carriage cover
170 Serving window
175 Publicity display
177 Mobile publicity device
179 Battery for the mobile publicity display
180 Solar panels
185 Sensor to detect a customer's arrival
190 Expansible roof
195 Expansible roof for drive-inside alternative
200 Roof solar reflectors
210 Menu
220 Window support table
230 Body carriage skirt
235 Body carriage wheels
240 Antenna
242 Antenna for the mobile display
260 Windows shield
270 Body carriage trailer hitch
275 Trailer hitch access door
280 Toilet
290 Sewer Tank
300 Gas tank
310 Bathroom wall
315 Office/Training room
318 Pest control unit
320 Bathroom door
330 External water connection
335 External gas connection
340 External electricity connection
350 Body carriage wall
360 Sewer tank door
370 Drive-inside corridor
380 Drive-inside corridor
390 Connection of expansible roof to body carriage cover
410 Body carriage vertical pistons
420 Body carriage chassis
425 Body carriage for accordion expansion
430 Accordion expanders
440 Body carriage for horizontal telescopic expansion
450 Body carriage cover for horizontal telescopic expansion
460 Body carriage horizontal pistons
470 Foot supports for horizontal telescopic expansion
510 Water meter
520 Water tank
530 Water pump
540 Water consumption points
550 Internal water connection
560 T water connector
570 Electricity meter
575 Electric rechargeable batteries
580 Electricity consumption points
585 Electricity generator
590 Electricity switch box
610 Gas meter
620 Gas tank
630 Gas consumption points
640 Internal gas connection
650 Gas T connector
680 Gray water valve
710 Step of positioning the linked mobile business and advertising unit close to customer traffic
712 Step of moving the linked mobile business and advertising unit to a desired place
714 Step of parking the linked mobile business in the desired place
716 Step of setting the linked mobile business and advertising unit ready for business transactions
720 Step of performing business transactions
722 Step of receiving an order from the customer
724 Step of charging the order to the customer
726 Step of delivering the order to the customer
730 Step of displaying publicity
732 Step of receiving the content of publicity for displaying
734 Step of receiving the publicity orders for displaying the content of publicity
736 Step of displaying the publicity according to the publicity orders
738 Step of evaluating the effect of publicity on sales
740 Step of communicating to at least one control unit
742 Step of sending information to at least one control unit
744 Step of receiving information from at least one control unit
750 Step of attending the plurality of linked mobile business and advertising units
751 Step sending information to the plurality of linked mobile business and advertising units
754 Step of receiving information to the plurality of linked mobile business and advertising units
760 Step of providing information services to the linked mobile business and advertising units
770 Step of selling space and time for publicity on the linked mobile business and advertising units
780 Step of locating the linked mobile business and advertising units in geographical areas

### DETAILED DESCRIPTION OF THE INVENTION

In order to understand the invention and to see how it may be carried out in practice, preferred and alternate embodiments will be described, by way of non-limiting examples, with reference to the accompanying drawings, and their parts.

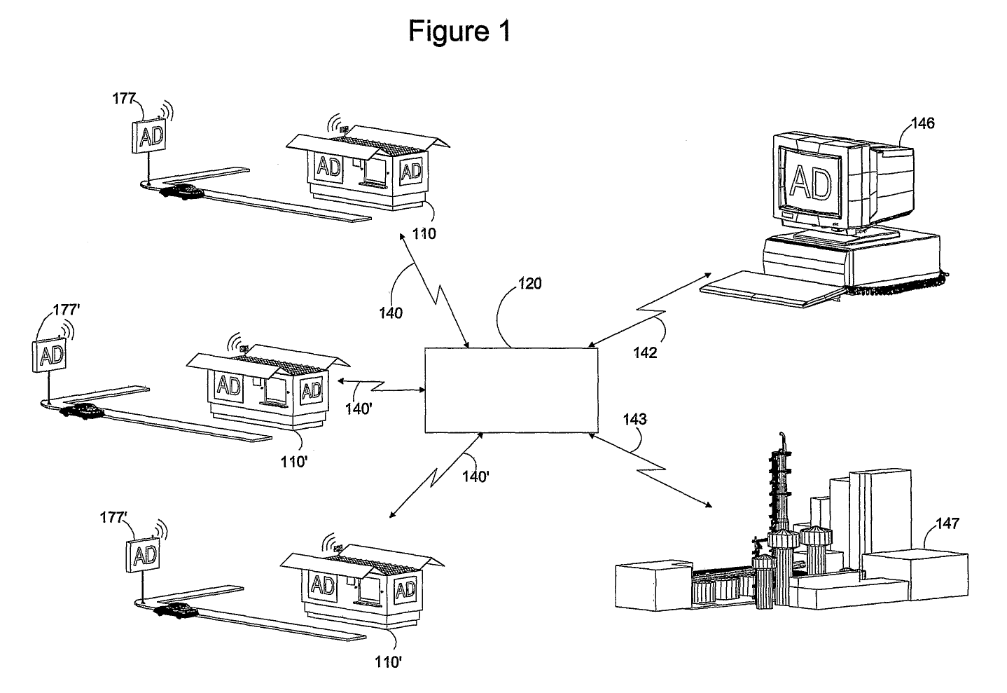

FIG. 1 is a diagram showing a chain of mobile business units that are linked to at least one control unit.

Description of FIG. 1. A group of linked mobile business and advertising units 110, 110′ form a chain. This chain of linked mobile business and advertising units 110, 110′ are connected to a control unit 120 through communications links 140, 140′. The control unit 120 connects to publicity clients 146 who want to display their ads on the linked mobile business units 110. The control unit 120 also connects to the manufacturer, producer or wholesaler 147 of the goods sold in the linked mobile business and advertising units 110, 110′. The control unit 120 connects to publicity clients 146 using communications link 142, and connects to manufacturers 147 using communication link 143.

Communications links 140, 140′, 142, 143 can carry bi-directional communications, and in another alternative they could carry unidirectional communications. These communications links can work in the public Internet, a private Intranet, a public network, a private network, or any combinations of these. Communication links 140, 140′, 142, 143 can use radio frequency, satellite, cellular, phone, or ultrasound technologies to transmit text, data, sound, or video information.

Operation of FIG. 1. The linked mobile business and advertising units 110, 110′ form a chain. Their income is mainly divided in two groups: first, selling goods or services, and second, selling publicity. The publicity does not necessarily have to be related to the goods or services sold in the unit. The different linked mobile business units 110, 110′ don't have to be in the same line of business. For instance, unit 110′ might be a coffee drive-thru, while unit 110′ might be a mobile vaccination center. Even when they are in different lines of business they have advantages for being part of the same chain.

They share administrative infrastructure, and they share many indirect expenses. They also together form synergy to sell their publicity devices for publicity campaigns. The control unit 120 will be able to send publicity to linked mobile business and advertising units 110, 110′ depending on their geographical position, customer segment, industry, calendar, and/or time. In addition to publicity, the control unit 120 can also send promotions to the business units 110, 110′.

Linked mobile business and advertising units 110, 110′ can send to control unit 120 their historical transactions, inventory levels, customers profiles, geographical positions, and/or service requests. Some examples of service requests are request to haul the unit to another geographical position, request for clean water refill, request for gas refill, request for electricity refill, and request for gray water removal, among other requests.

The control unit 120 can decide if the linked mobile business and advertising unit 110 can receive, send, and share information from other linked mobile business and advertising units 110′. For instance they might need to share inventory levels to be able to tell a customer in which unit a specific product can be found. Also, they might need to share customer profiles to be able to recognize the same customer in different units and provide that customer the same treatment, the same prices, the same discounts, the same customized promotions, and maintain a single database with the history of its operations.

The lines of business for these linked mobile business and advertising units 110, 110′ can be of many different types. Different lines of business include a store, a fast-food establishment, a restaurant, a catering stand, a laundry, a post office, a courier stand, a package delivery service, a vaccination center, a wedding chapel, a tourist information center, a funeral service, a voting place, a catalog pickup and devolution center, a coupon exchange center, a tax service, a cinema, a church, a car wash, a bank, an office, a money transfer center, a cyber cafe, an Internet access point, a training center, a medical service place, a ticket center, and a mechanical service garage, among others.

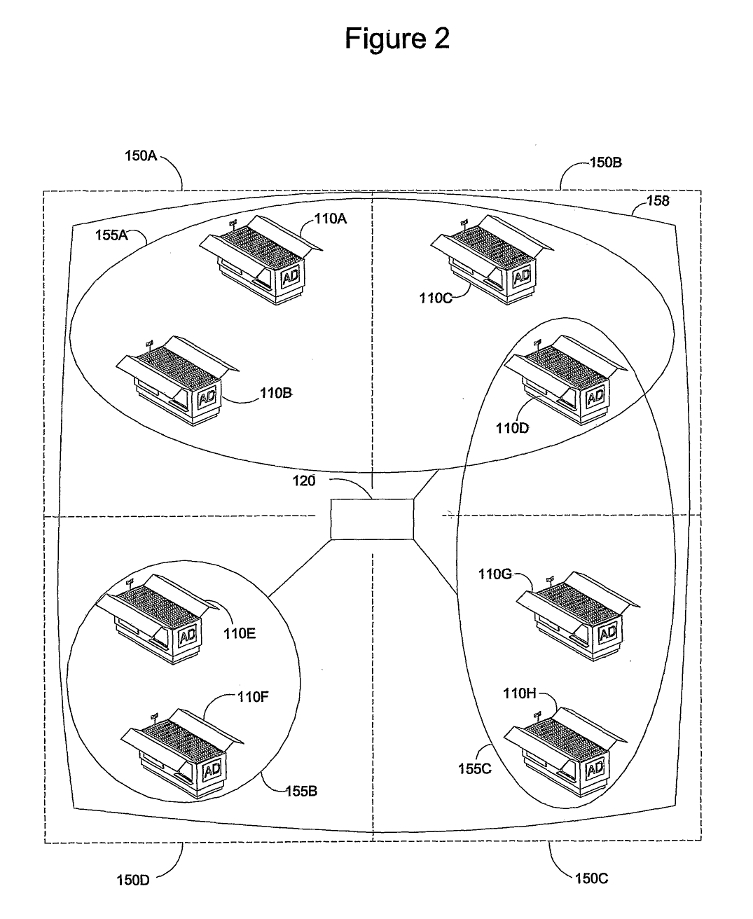

FIG. 2 is a diagram showing subchains of linked mobile business and advertising units spread in different geographical areas.

Description of FIG. 2. A chain can be divided in smaller chains, also called subchains. Linked mobile business and advertising units 110A, 110B, 110C, and 110D form subchain 155A. Linked mobile business and advertising units 110E, and 110F form subchain 155B. Linked mobile business and advertising unit 110D, 110G, and 110H form subchain 155C. Subchains 155A, 155B, and 155C form chain 158. Each subchain 155 can have smaller sub sub chains in it. Geographical zones 150A, 150B, 150C, and 150D are different areas where the linked mobile business and advertising units 110 are located. A linked mobile business and advertising unit 110 can be a part of one or more subchains 155. A linked mobile business and advertising unit 110 can be a part of a geographical zone 150. There can be different geographical zones 150. Each geographical zone 150 can have smaller geographical areas in it. The control unit 120 can be inside or outside geographical zones 150.

Operation of FIG. 2. The control unit 120 can send orders and information content to the linked mobile business and advertising units 110. One example of an order is the one to display a specific publicity to those linked mobile business and advertising units 110 that are located in the northwest part of a city. Another example would be an order to give promotional discounts to a subchain formed by coffee drive-thrus. Another example would be to turn-on display devices and display publicity during specific non-operating hours of units 110 that are located near a road that has temporary traffic due to an extraordinary event. Actually, the control unit 120 can send orders and content to the linked mobile business and advertising units 110 based on a combination of such criteria as geographical position, line of business, industry served, calendar, time, and type of display.

Subchain 155A operates with less indirect costs because it shares these costs with subchains 155B, and 155C. For instance, the cost of logistics for transporting clean water, the cost of logistics for removing gray water, the cost of control unit 120, the cost to go out an sell publicity, and other costs are shared by all subchains 155. This is how a small subchain with only few units, spreads its costs as if it had large-scale operations.

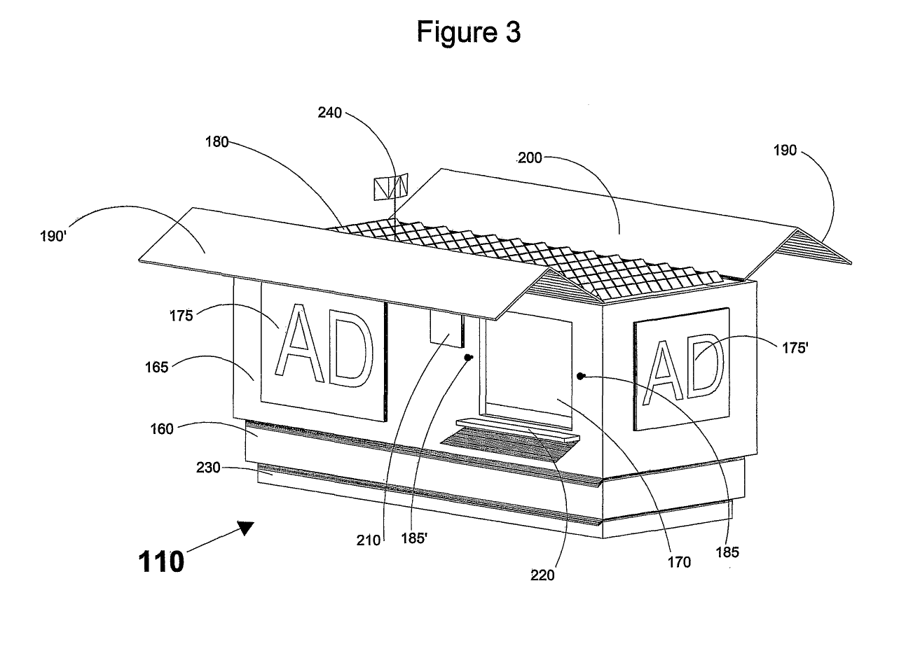

FIG. 3 is a perspective view showing the front, top, and right sides of the preferred embodiment of the linked mobile business and advertising unit when expanded, parked, and in operation.

Description of FIG. 3. The linked mobile business and advertising unit 110 has a body carriage 160 formed by a plurality of walls and a floor. A body carriage cover 165 is on the top of body carriage 160 formed by a plurality of walls and a roof. Body carriage cover 165 is positioned telescopically over body carriage 160. The materials for these body carriage 160, and body carriage cover 165 can be steel, wood, plastic, aluminum, sheet rock, materials made from stones, materials made from minerals, or any other construction material. On the walls of body carriage cover 165 there is a serving window 170. On the walls of body carriage cover 165 there are publicity displays 175, and 175′. These publicity devices 175, and 175′ can be windows, exhibitors, panels, screens, liquid crystal displays, electronic papers, film substrate based displays, cathodic ray tubes CRT's, grids, speakers, mechanical machines, electric machines, electronic machines, light-bulb arrays, banners, television sets, flat TV sets, High Definition TV sets, or any other kind of publicity display. These publicity displays 175, 175′ can be fixed on the unit 110, or be mobile to be positioned apart from the unit 110, and close to customer traffic. The solar panels 180 are positioned on the top of the body carriage cover 165. Next to the solar panels are the expansible roofs 190, which on the inside have solar reflectors 200.

Beside the serving window 170 there is a menu 210 that can be replaced. Below the serving window 170 there is a support bar 220 which can be attached and detached. Inside body carriage 160 there is a body carriage skirt 230 that has vertical telescopic movement to start from the inside of body carriage 160 to end below of body carriage 160. On the top of body carriage cover 165 there is an antenna 240 to communicate to at least one control unit 120 (FIG. 1), and to other points. The communications handled by this antenna 240 can be radio frequency, satellite, cellular, phone, or ultrasound technologies to transmit text, data, sound, or video information.

Sensors 185, 185′ to detect a customer's arrival can be mechanical sensors, optical sensors, thermal sensors, sound sensors, and motion sensors. Once these sensors 185, 185′ are triggered they signal the arrival of a customer, display special publicity, and promotions.

Operation of FIG. 3. Customers arrive to the linked mobile business and advertising unit 110, and can look to the menu 210 to decide what products and/or services they want to buy. The customer receives attention in the service window 170. While the customer is being helped, the customer may look at publicity on publicity panel 175. The publicity may be controlled locally or remotely. The expansible roof 190 covers the customer from weather mishaps, such as too much sun, or rain. The solar reflectors 200 increase the solar light reception at the solar panels 180. A historical record of the transaction is sent through the antenna 240 to a control unit 120 (FIG. 1). Through the antenna 240 the linked mobile business and advertising unit 110 also receives from at least one control unit 120 (FIG. 1) orders and information content,

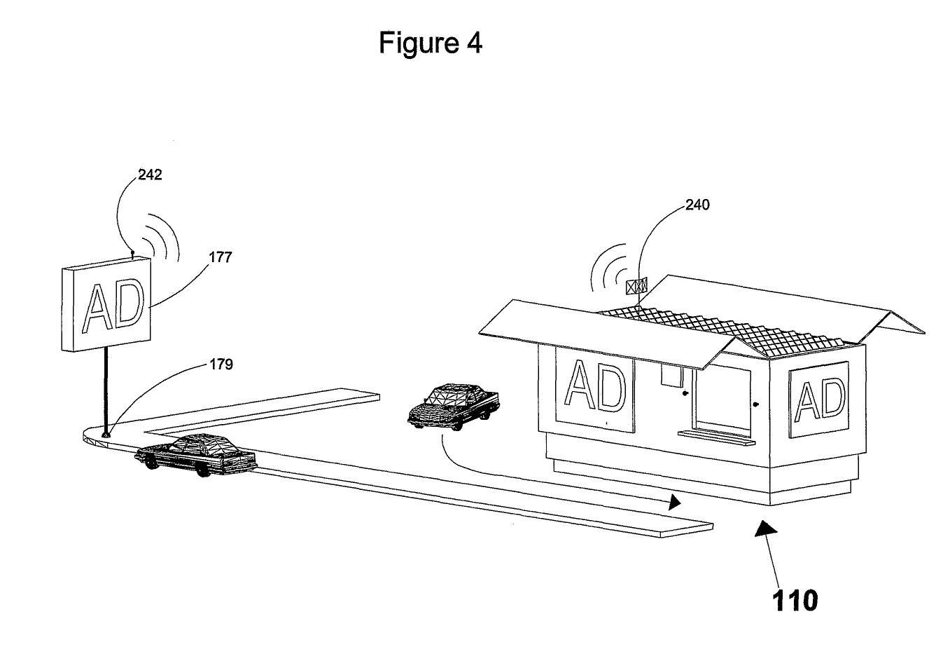

FIG. 4 is a perspective view showing the preferred embodiment of the linked mobile business and advertising unit using a mobile display device.

Description of FIG. 4. A mobile publicity device 177 can be positioned away of the linked mobile business and advertising unit 110. The mobile publicity device 177 has an antenna 242 to communicate with the antenna 240 of the linked mobile business and advertising unit 110. There can be a plurality of mobile publicity devices 177, 177′ (not shown) connected to a linked mobile business and advertising unit 110. The mobile publicity devices 177, 177′ (not shown) can be panels, screens, liquid crystal displays, electronic papers, film substrate based displays, cathodic ray tubes CRT's, grids, speakers, mechanical machines, electric machines, electronic machines, light-bulb arrays, banners, television sets, flat TV sets, High Definition TV sets, or any other kind of publicity display. The lower part of the mobile publicity device 177 has a rechargeable battery 179.

Operation of FIG. 4. The linked mobile business and advertising unit 110 can receive publicity content and orders from the control unit 120 (FIG. 1), or it can locally receive publicity content and orders. The linked mobile business and advertising unit 110 sends publicity content according to the publicity orders to the mobile publicity device 177. The communication between the linked mobile business and advertising unit 110 and the mobile publicity device 177 is done through the antennas 240 and 242. However, the communication doesn't need to be wireless, there could be a wire going from the linked mobile business and advertising unit 110 to the mobile publicity device 177. The mobile publicity device 177 takes its energy from the battery 179.

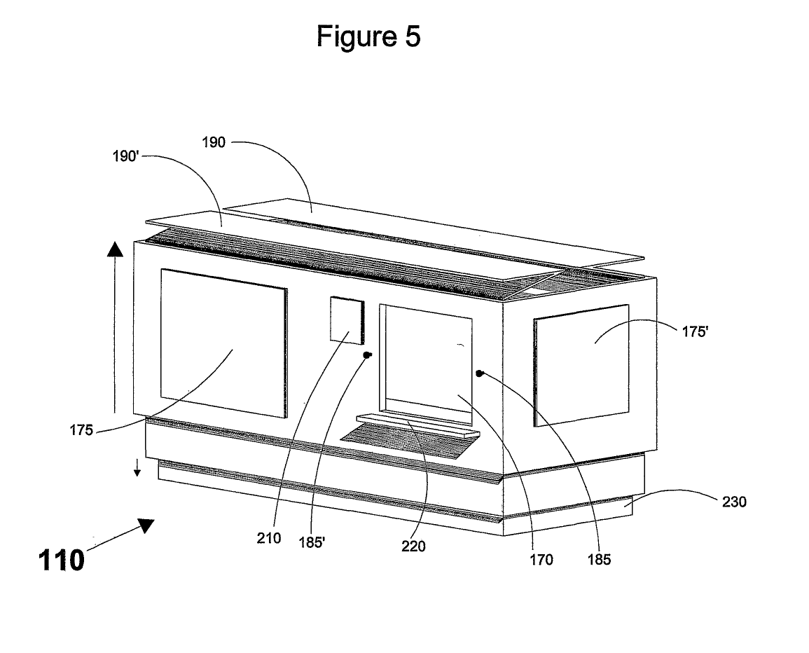

FIG. 5 is a perspective view showing the front, top, and right sides of the preferred embodiment of the linked mobile business and advertising unit when in the process of expanding.

Description of FIG. 5. The expansible roofs 190, 190′ can use hydraulic devices, mechanical devices, elastic devices, ropes, conveyors, toothed wheels, or any combination thereof, to perform the expansion and the retraction. When retracted, the roofs 190, 190′ protect the solar panels 180 (FIG. 3). The menu 210 can be removed and installed for every day of operations. The support bar 220 can be attached and detached for every day of operations. The serving window 170 can be locked or unlocked.

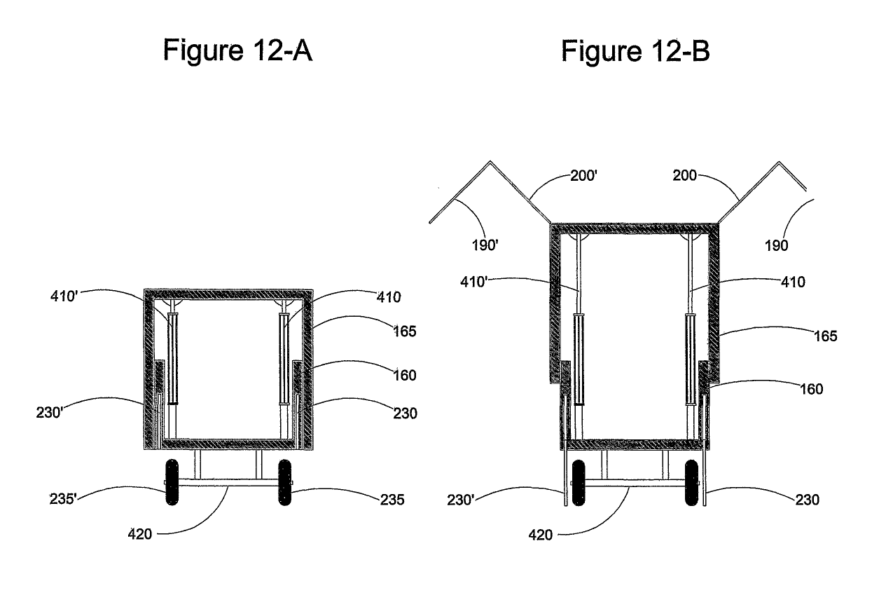

Operation of FIG. 5. When the linked mobile business and advertising unit 110 starts operations it moves from a position where it was retracted, to a position where it will be expanded. Unit 110 increases its volume by a telescopic movement of its body carriage cover 165 (FIG. 3) up from its body carriage 160 (FIG. 3). The expansible roofs 190 are expanded. They were retracted covering the solar panels 180 (FIG. 3), and in FIG. 5 they are shown expanded to let the solar panels 180 (FIG. 3) receive solar light, and to protect the customer from weather mishaps such as too mush sun, or rain. Publicity displays 175, and 175′ start showing publicity. The body carriage skirt 230 is moved down to protect the body carriage wheels 235 (FIG. 12-A). This body carriage skirt 230 comes down telescopically from inside of body carriage 160 (FIG. 3).

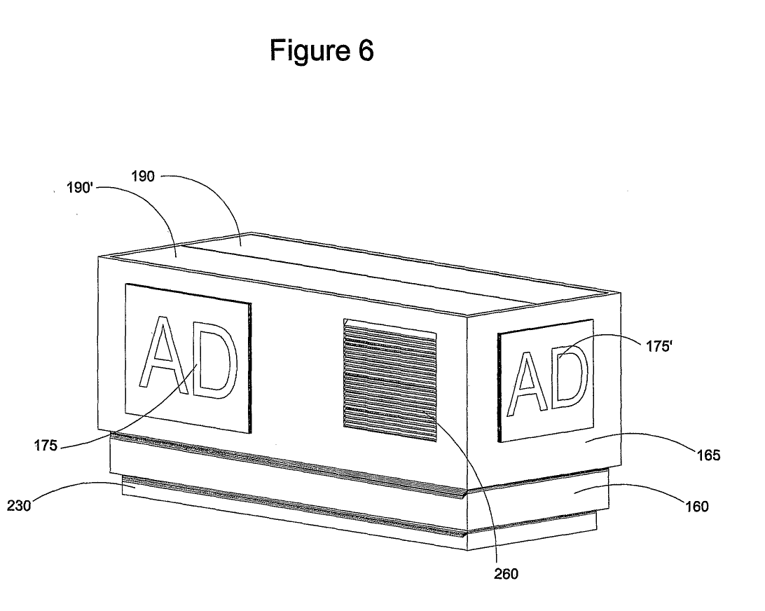

FIG. 6 is a perspective view showing the front, top, and right sides of the preferred embodiment of the linked mobile business and advertising unit when is non-operational, parked and secured.

Description of FIG. 6. The expansible roofs 190, 190′ are completely retracted protecting the solar panels 180 (FIG. 3). A window shield 260 covers and protects the serving window 170 (FIG. 3). The publicity panels 175, 175′ are programmed to be on or off during non-operating hours. The body carriage skirt 230 is made of peripheral walls coming from the inside of the peripheral walls of body carriage 160.

Operation of FIG. 6. This position of the linked mobile business and advertising unit 110 is used when the unit 110 is parked and secured, i.e., when is not in operation. For example, at the end of the day, the unit is left alone. There is a risk of vandalism and attacks. The expansible roofs 190, and 190′ are retracted and locked to protect the solar panels 180 (FIG. 3). The window shield 260 protects the serving window 170 (FIG. 3). The body carriage skirt 230 protects the wheels 235 (FIG. 12-A).

When the linked mobile business and advertising unit 110 is parked and not operating, it still has communication with the control unit 120 (FIG. 1). Thus control unit 120 (FIG. 1) can order the linked mobile business and advertising unit 110 to turn on a publicity displays 175, 175′ and start displaying publicity. The displayed publicity will start at a time, and end a time controlled by the control unit 120 (FIG. 1). The displayed publicity will have the content ordered by the control unit 120 (FIG. 1). Additionally, the linked mobile business and advertising unit 110 can program its own schedule and content of publicity for non-operating hours without the help or control of control unit 120 (FIG. 1).

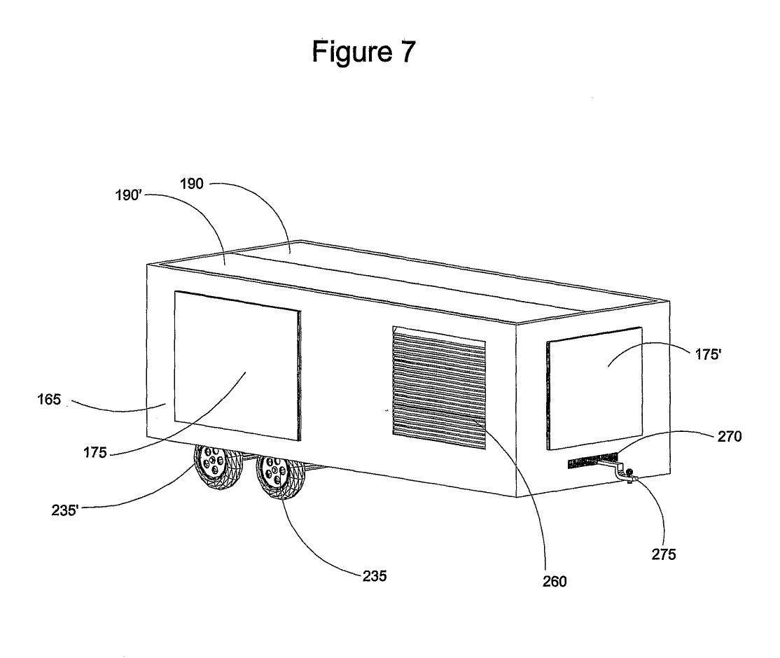

FIG. 7 is a perspective view showing the front, top, and right sides of the preferred embodiment of the linked mobile business and advertising unit when retracted and ready to move.

Description of FIG. 7. The body carriage cover 165 is telescopically covering the body carriage 160 (FIG. 3). The body carriage trailer hitch 270 is extracted through a trailer hitch access door 275. The body carriage skirt 230 (FIG. 3) is retracted telescopically inside body carriage 160 (FIG. 3), which at the same time is retracted inside body carriage cover 165. Wheels 235, and 235′ are below body carriage 160 (FIG. 3). Window shield 260 protects the serving window 170.

Operation of FIG. 7. In order to move the linked mobile business and advertising unit 110 the body carriage skirt 230 (FIG. 3) is retracted telescopically inside body carriage 160 (FIG. 3) leaving the wheels 235, and 235′ uncovered. The linked mobile business and advertising unit 110 can be towed using the body carriage trailer hitch 270 which is pulled out from inside of body carriage 160 (FIG. 3) using the trailer hitch access door 275. The linked mobile business 110 is retracted while it is being towed to comply with laws regulating transportation unit dimensions. Its expansible roofs 190, and 190′ are retracted and locked to protect the solar panels 180 (FIG. 3). Its serving window 170 (FIG. 3) is protected with the window shield 260.

The linked mobile business and advertising unit 110 can be moved from very short distances (yards), to very long distances (tens of thousands of miles) using this shape. While moving, the control unit 120 (FIG. 1) will know the geographical position of the linked mobile business and advertising unit 110 using one or more of various technologies, or a combination of them, including GPS, radio frequency, array of access points, cellular identification, satellite identification, or pager identification.

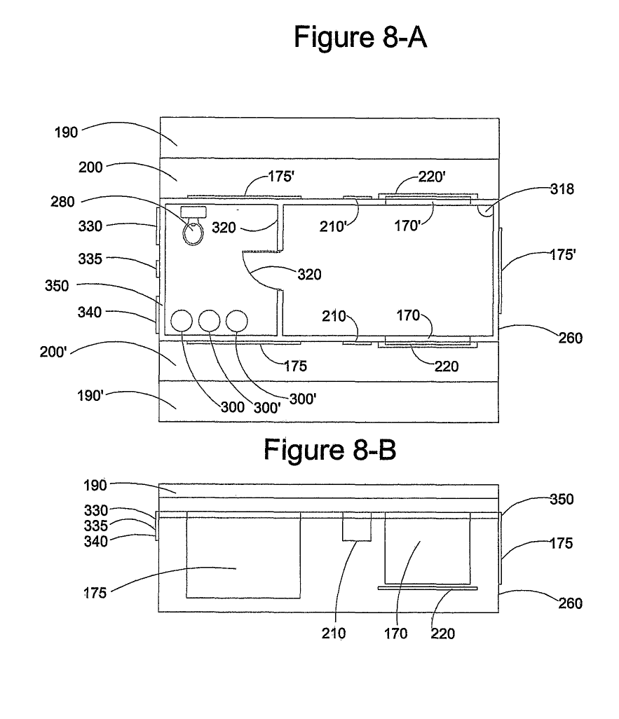

FIG. 8-A and FIG. 8-B are, respectively, an upper view, and a frontal view showing the preferred embodiment of the linked mobile business and advertising unit when expanded, parked, and in operation.

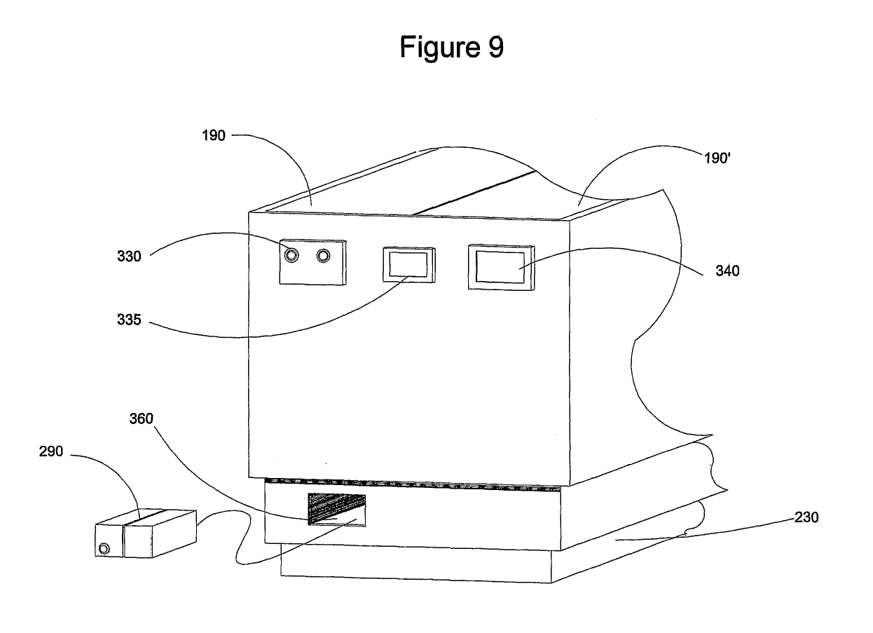

FIG. 8-A and FIG. 8-B description. A toilet 280, a sewer tank 290, and a gas tank 300 are in a room formed by an interior bathroom wall 310 that connects to the peripheral walls of body carriage 160 (FIG. 3). The interior bathroom wall 310 has a bathroom door 320 to allow access. On the exterior of body carriage cover 165 (FIG. 3) at the back wall 350 there are connections for water 330 and connections for gas 335, and electricity 340. Also, the sewer tank door 360 (FIG. 9) is on wall 350. The pest control unit 318 is located in a corner.

FIG. 8-A and FIG. 8-B operation. The toilet 280 allows employees or operators to stay inside the linked mobile business and advertising unit 110. Gas is stored in gas tanks 300, and 300′. Water and gas can be added using respectively their connections 330, and 335. Electricity can be added using connection 340. This enables the linked mobile business and advertising unit 110 to receive these resources from the outside. On the other side of the bathroom wall 310, a training room can be installed for employees or operators using virtual education, distance learning education, or self-education. The pest control unit 318 helps prevent goods against any bug.

FIG. 9 is a perspective view showing the front, top, and right sides of the preferred embodiment of the linked mobile business and advertising unit when it's non-operational, parked and secured, and clarifying the connections to the exterior for services such as water, electricity, gas and the sewer tank.

Description of FIG. 9. A sewer tank 290 is shown that can be withdrawn from the linked mobile business and advertising unit 110 (FIG. 3) using a sewer tank door 360. There are connections for receiving water 330, gas 335, and electricity 340 on the body carriage wall 350.

Operation of FIG. 9. Without the need of for any person to be present inside the linked mobile business and advertising unit 110 (FIG. 3), the sewer tank 290 can be extracted from the outside through the sewer tank door 360. This makes easier the process of removing gray water because the sewer tank 290 can be removed at any time, when the unit is operating, or when the unit is not operating.

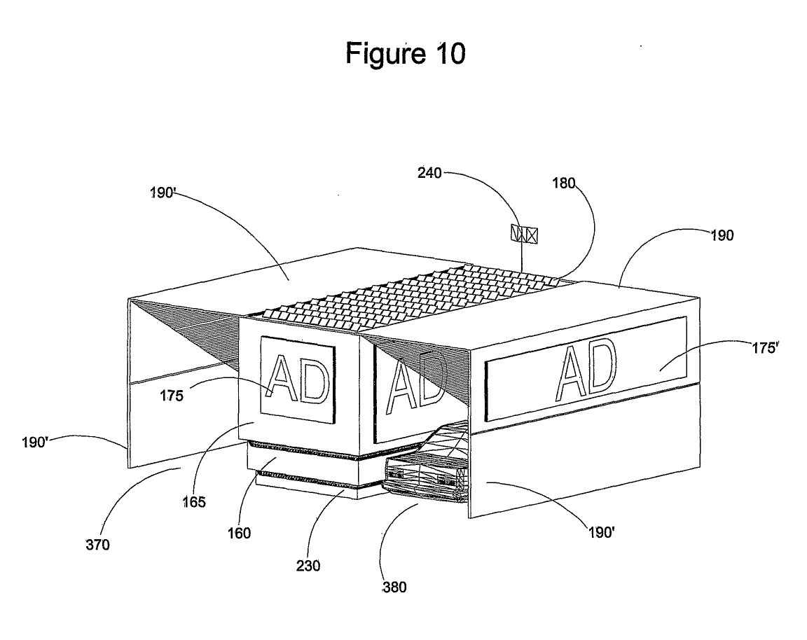

FIG. 10 is a perspective view showing the front, top, and right side views of an alternative embodiment of the linked mobile business and advertising unit when expanded, parked, and in operation. This is a “drive-inside” alternative.

Description of FIG. 10. This figure shows drive-inside expansible roofs 195, and 195′ that go all the way from the top of the body carriage cover 165 to the external floor. The remaining parts are built as described in FIG. 3.

Operation of FIG. 10. This figure shows an example of a “drive-inside” business unit. Cars drive inside the business unit using drive-inside corridors 270, and 280. There can be publicity inside or outside these corridors. Also, there can be products in these corridors for display or for sell. The rest of the operation is the same as in FIG. 3.

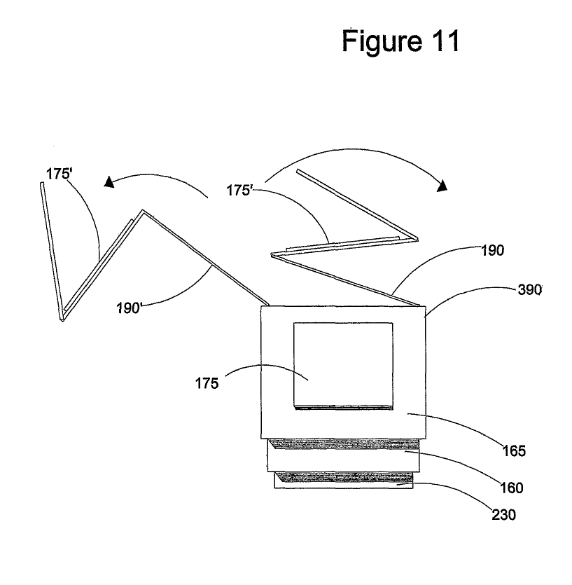

FIG. 11 is a right side view of the “drive-inside” alternative embodiment of the linked mobile business and advertising unit showing when is in the process of expanding.

Description of FIG. 11. The drive-inside expansible roofs 195, and 195′ are made of folding parts. The first folding part connects to body carriage cover 165 at the edge 390. The first folding part is moved 180 degrees from its original position, forming a 90-degree angle with the wall of body carriage cover 165. The second folding part is moved until it forms a 90-degree angle with the first part, and the third part is moved until it touches the external floor forming a 180-degree angle with the second part.

Operation of FIG. 11. The expansible roofs 195, and 195′ can use hydraulic devices, mechanical devices, elastic devices, ropes, conveyors, toothed wheels, among others, or any combination of them, to perform the expansion and the retraction.

FIG. 12-A and FIG. 12-B are cross-section views showing respectively, first, a view from the right side of the preferred embodiment of the linked mobile business and advertising unit when is non-operational, parked and secured, using a vertical telescopic retraction; and, second, a view from the right side of the preferred embodiment of the linked mobile business and advertising unit when is operational using a vertical telescopic expansion.

Description of 12-A and FIG. 12-B. The body carriage cover 165 is telescopically positioned over body carriage 160. Inside body carriage 160 the body carriage skirts 230, 230′ are telescopically positioned. The wheels 235, 235′ hold the chassis 420 that carries the body carriage 160. The vertical pistons 410, 410′ go from the floor of body carriage 160 to the roof of body carriage cover 165.

Operation of FIG. 12-A and FIG. 12-B. The linked mobile business and advertising unit 110 (FIG. 3) can increase or decrease its volume. It can decrease its volume to be towed in an easier way, and to comply with transportation regulations. It can increase its volume to have a more comfortable environment of operation, and to comply with laws regulating working environments.

The linked mobile business and advertising unit 110 (FIG. 3) increases and decreases its volume using vertical pistons 410, 410′. In this preferred embodiment, these vertical pistons 410 work hydraulically using a telescopic movement. However, in other embodiments, volume increase and decrease may be achieved using other devices such as hydraulic devices, mechanical devices, elastic devices, ropes, toothed wheels, conveyors, or any combination of them, among others.

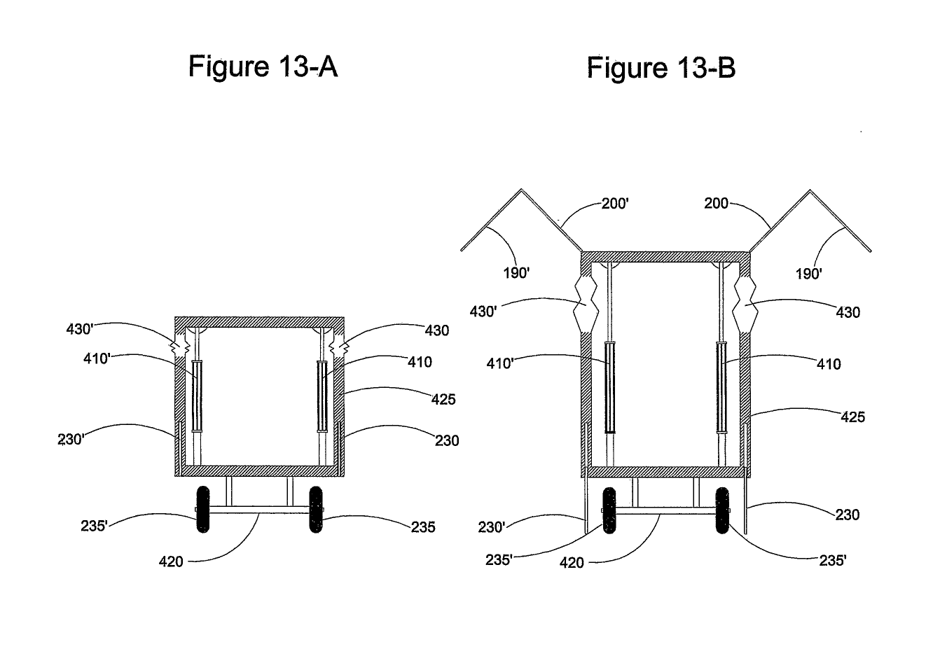

FIG. 13-A and FIG. 13-B are cross-section views showing, respectively, a view from the right side of an alternative embodiment of the linked mobile business and advertising unit when is non-operational, parked, and secured, using a vertical accordion retraction; and a view from the right side of an alternative embodiment of the linked mobile business and advertising unit when is operational, using a vertical accordion expansion.

Description of FIG. 13-A and FIG. 13-B. The body carriage for accordion expansion 425 has accordion expanders 430, 430′. Inside body carriage for accordion expansion 425 the body carriage skirts 230, 230′ are telescopically positioned. The wheels 235, 235′ hold the chassis 420 that carries the body carriage for accordion expansion 425. The vertical pistons 410, 410′ go from floor to roof of the body carriage for accordion expansion 425.

Operation of FIG. 13-A and FIG. 13-B. The volume inside body carriage for accordion expanders 425 can be increased or decreased. In this alternative embodiment there is no telescopic body carriage. Instead of telescoping expansion, the body carriage 425 increases its volume using accordion expanders 430, and 430′. A smaller volume makes towing an easier task. It's also easier to comply with transportation regulations with a small volume. A larger volume creates a more comfortable environment of operation. Also, a larger volume makes it easier to comply with laws regulating working environments.

Vertical pistons 410 are responsible for increasing or decreasing the unit's volume. In this alternate embodiment, these vertical pistons 410 work hydraulically using a telescopic movement. However, in other embodiments, variations in volume may be achieved using other devices such as hydraulic devices, mechanical devices, elastic devices, ropes, conveyors, toothed wheels, or any combination of them, among others.

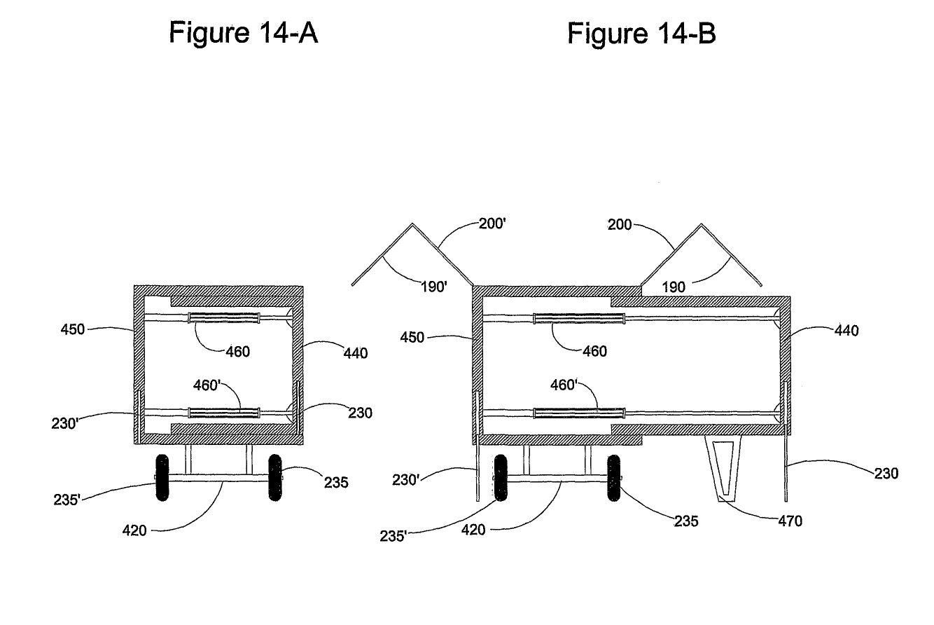

FIG. 14-A and FIG. 14-B are cross-section views showing, respectively, a view from the right side of an alternative embodiment of the linked mobile business and advertising unit when is non-operational, parked and secured, using a horizontal telescopic retraction; and a view from the right side of an alternative embodiment of the linked mobile business and advertising unit when is operational using a horizontal telescopic expansion.

Description of FIG. 14-A and FIG. 14-B. A body carriage for horizontal expansion 440 and a body carriage cover for horizontal expansion 450 are assembled telescopically. Chassis 420 hold the body carriage cover for horizontal expansion 450. Wheels 235, and 235′ support the chassis 420. Horizontal pistons 460, and 460′ go from wall of body carriage for horizontal expansion 440 to the wall of body carriage cover for horizontal expansion 450.

Body carriage skirt 230 is held telescopically inside of body carriage for horizontal expansion 440. Body carriage skirt 230′ is held telescopically inside of body carriage cover for horizontal expansion 450. A foot support 470 is positioned below body carriage for horizontal expansion 440.

Operation of FIG. 14-A and FIG. 14-B. Volume inside body carriage for horizontal expansion 440 and its cover 450 can be increased or decreased. In this alternative embodiment a telescopic increase is performed horizontally. An increased volume helps to be towed in an easier way, and to comply with transportation regulations. An increased volume helps to have a more comfortable environment of operation, and to comply with laws regulating working environments.

The increase and decrease of volume is done using horizontal pistons 460, and 460′. In this alternate embodiment, these horizontal pistons 460, and 460′ work hydraulically using a telescopic movement. However, in other embodiments, volume increase and decrease may be achieved using other devices, or combinations of them, such as hydraulic devices, mechanical devices, elastic devices, ropes, conveyors, toothed wheels, or any combination of them, among others.

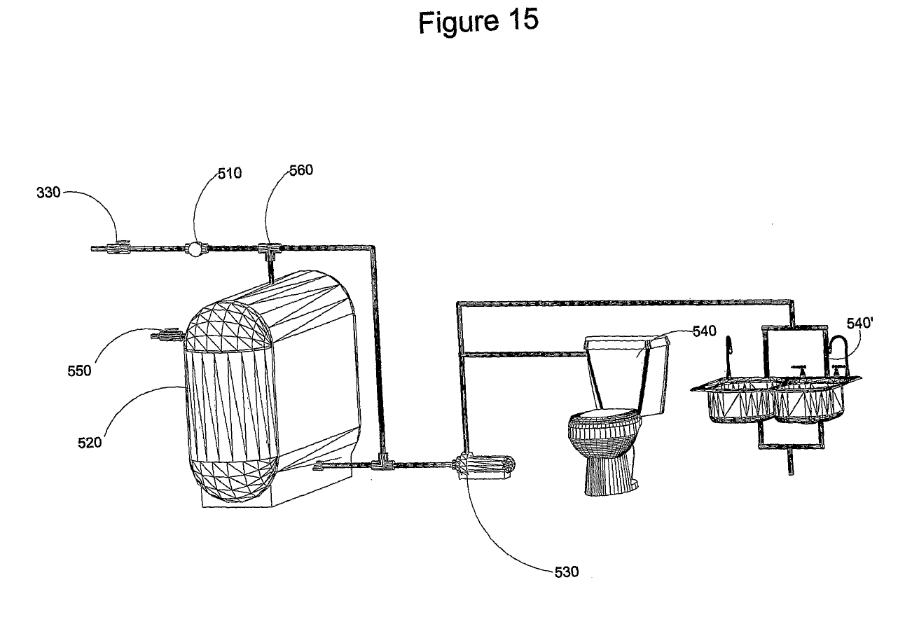

FIG. 15 is a schematic diagram showing the reception, storage, and consumption of clean water.

Description of FIG. 15. The linked mobile business and advertising unit 110 (FIG. 3) has an external water connection 330 to receive water from the exterior. The external water connection 330 is connected through a pipe to a water meter 510. The water meter 510 is connected to a water T connection 560 that has two outputs. The first output of water T connection 560 goes to water tank 520. The second output of water T connection 560 goes to water consumption points 540. Water tank 520 can also receive water from inside the linked mobile business and advertising unit 110 (FIG. 3) using a internal water connection 550. Water received from either the water tank 520 or the water T connection 560 goes to a water pump 530 that pumps the water and gives it pressure. The water pump 530 supplies water with pressure to water consumption points 540. Water can be transmitted through pipes, plumbs, tubes, plastics, hoses, or any combination of them.

Operation of FIG. 15. The linked mobile business and advertising unit 110 (FIG. 3) can receive clean water from inside the linked mobile business and advertising unit 110 (FIG. 3) or from outside the linked mobile business and advertising unit 110 (FIG. 3). To receive water from the inside there is an internal water connection 550. To receive water from the outside there is an external water connection 330. There is a water meter 510 to let operators know how much water is coming from outside the linked mobile business and advertising unit 110 (FIG. 3). This water meter 510 will allow operators to buy water while they are on the go from different suppliers. Additional water meters can be installed in different parts of the water pipeline configuration to provide different measures. Additionally, the water pump 530 is provided to ensure proper water pressure at water consumption points 540.

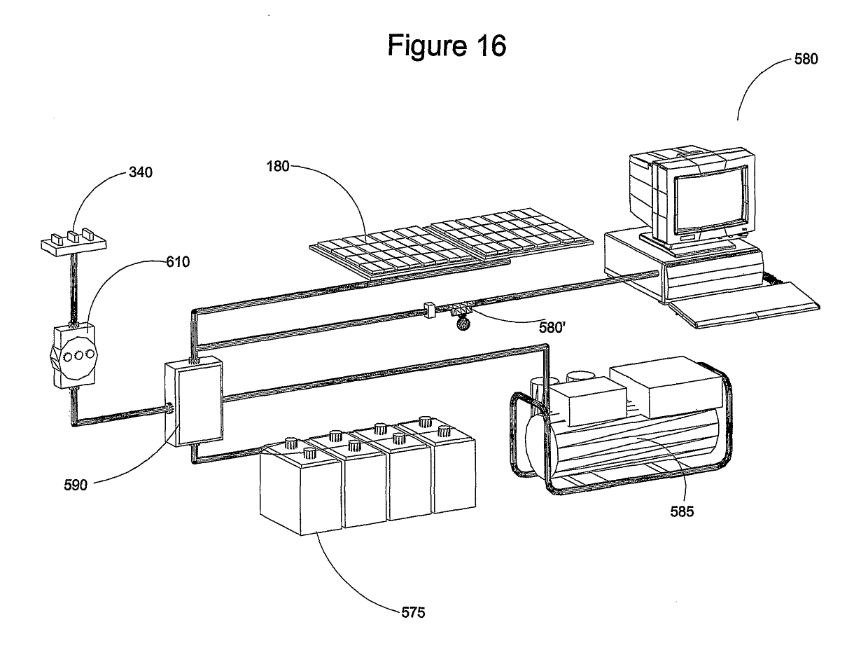

FIG. 16 is a schematic diagram showing the reception, storage, and consumption of electricity.

Description of FIG. 16. The linked mobile business and advertising unit 110 (FIG. 3) has an external electricity connection 340 to receive electricity from the exterior. The external electricity connection 340 is connected to an electricity meter 570. The electricity meter 570 is connected to an electric switch box 590. The electric switch box 590 can route electricity in two different directions. The first output of the electric switch box 590 is to a set of rechargeable batteries 575. The second output of the electric switch box 590 is to electricity consumption points 580, 580′. The rechargeable batteries 575 can receive electricity from solar panels 180. The rechargeable batteries 575 can send electricity directly to electricity consumption points 580, 580′. Electricity can be transmitted through cables, wires, conductors, on any combination of them.

Operation of FIG. 16. The linked mobile business and advertising unit 110 (FIG. 3) can receive electricity from solar panels 180, or from a portable electricity generator (not shown), or from any source from inside or outside the linked mobile business and advertising unit 110 (FIG. 3). It has the flexibility to store the received electricity in rechargeable batteries 575, or to send the electricity to electricity consumption points 580, 580′. To receive electricity from outside the linked mobile business and advertising unit 110 (FIG. 3) there is an external electricity connection 340. There is an electricity meter 570 to let operators know how much electricity is coming from outside the linked mobile business and advertising unit 110 (FIG. 3). This electricity meter 570 will allow operators to buy electricity while they are on the go from different suppliers. Additional electricity meters can be installed in different parts of the electricity gridline configuration inside the linked mobile business and advertising unit 110 (FIG. 3) to provide different measures.

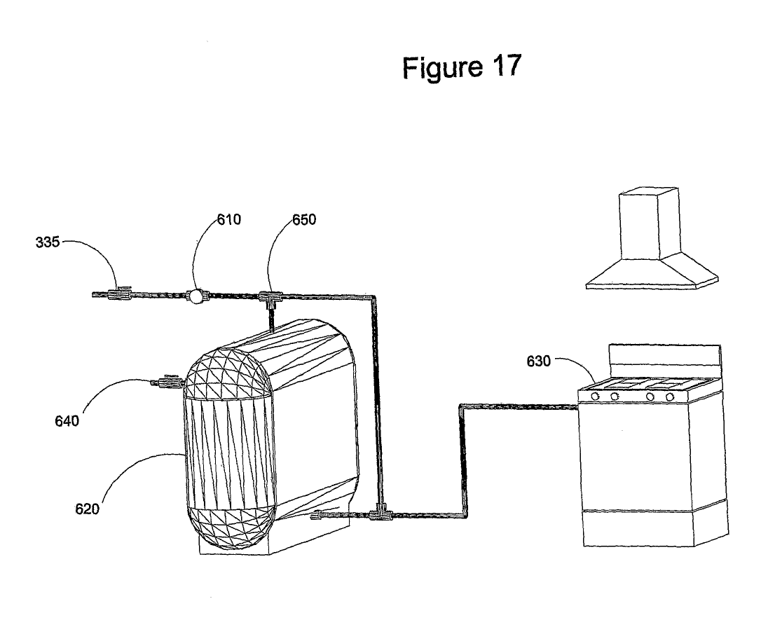

FIG. 17 is a schematic diagram showing the reception, storage, and consumption of gas.

Description of FIG. 17. The linked mobile business and advertising unit 110 (FIG. 3) has an external gas connection 335 to receive gas from the exterior. The external gas connection 335 is connected through a pipe to a gas meter 610. The gas meter 610 is connected to a gas T connection 650 that has two outputs. The first output of gas T connection 650 goes to gas tank 620. The second output of gas T connection 650 goes to gas consumption points 630. Gas tank 620 can also receive gas from inside the linked mobile business and advertising unit 110 (FIG. 3) using a internal gas connection 640. Gas received from either the gas tank 620 or the gas T connection 650 goes to gas consumption points 630. Gas can be transmitted through pipes, plumbs, tubes, plastics, hoses, or any combination of them.

Operation of FIG. 17. The linked mobile business and advertising unit 110 (FIG. 3) can receive gas from the inside or the outside. To receive gas from the inside there is an internal gas connection 640. To receive gas from the outside there is an external gas connection 335. There is a gas meter 610 to let operators know how much gas is coming from outside the linked mobile business and advertising unit 110 (FIG. 3). The gas meter 610 will help operators measuring gas bought, while they are on the go, from different suppliers. Additional gas meters can be installed in different parts of the gas pipeline configuration inside the linked mobile business and advertising unit 110 (FIG. 3) to provide different measures.

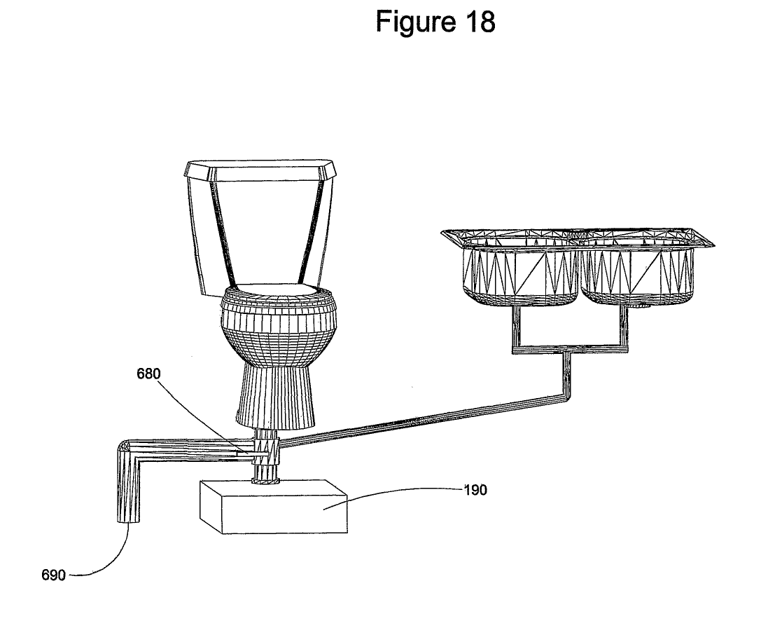

FIG. 18 is a schematic diagram showing the sewer tank, and gray water handling.

Description of FIG. 18. Gray water or used water goes to a gray water valve 680. The gray water valve 680 can send gray water to either the sewer tank 290, or a gray water connection 690.

Operation of FIG. 18. The linked mobile business and advertising unit 110 (FIG. 3) has the flexibility to keep its gray water or its used water in a sewer tank 290, or send it outside to a drain service through a gray water connection 830. Additionally, the sewer tank 290 can be removed to be cleaned or to be replaced by an empty one.

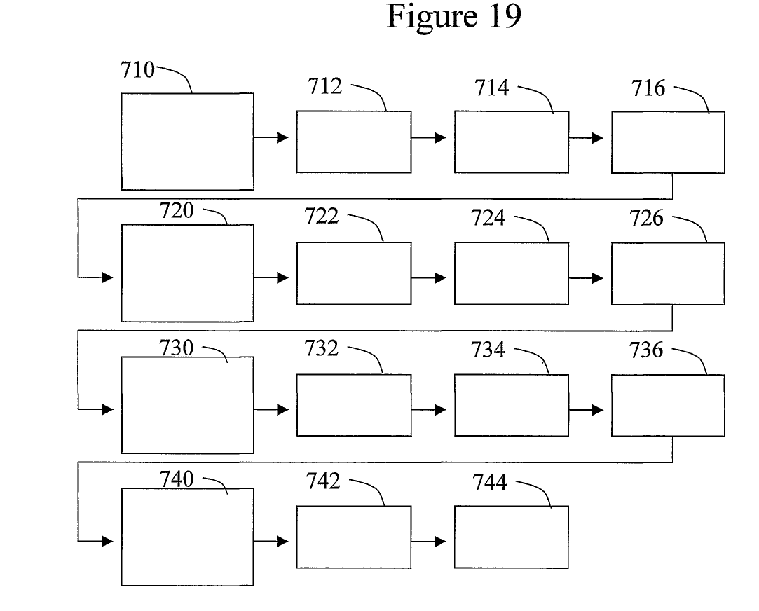

FIG. 19 is a block diagram illustrating the method for operating the linked mobile business and advertising unit.

Description of FIG. 19. The major steps for this method for operating the linked mobile business and advertising unit are 710 positioning the linked mobile business and advertising unit in a place close to customer traffic, 720 performing business transactions, 730 displaying publicity, and 740 communicating to at least one control unit. Each of these major steps is composed of several minor steps, also called substeps.

Step 710 positioning the linked mobile business and advertising unit in a place close to customer traffic is composed by steps 712 moving the linked mobile business and advertising unit to a desired place, 714 parking the linked mobile business and advertising unit in the desired place, and 716 setting the linked mobile business and advertising unit ready for business transactions.

Step 720 performing business transactions is composed by steps 722 receiving an order from the customer, 724 charging for the order to the customer, and 726 delivering the order to the customer.

Step 730 displaying publicity is composed by steps 732 receiving the content of publicity for displaying, 734 receiving the publicity orders for displaying the content of publicity, and 736 displaying the publicity according to the publicity orders. There is an optional additional step 738 (not shown) evaluating the effect of publicity on sales.

Step 740 communicating to at least one control unit is composed by steps 742 sending information to at least one control unit, and step 744 receiving information from at least one control unit.

While this is a desired order of steps, there is no strict need to follow such order. Those of ordinary skill in the art having the benefit of the present disclosure will appreciate that many variations on the ordering of steps illustrated in FIG. 19 can be carried out.

Operation of FIG. 18. The operational process of FIG. 19 starts with step 712 involving the activities for moving the linked mobile business and advertising unit to a desired place. The linked mobile business and advertising unit can be self-propelled or moved by someone else. The idea is to get close to customer traffic. While the linked mobile business and advertising unit is moving from one place to another, it's volume can be retracted. With a smaller volume it will be easier to comply with transportation regulations.

It is in step 712 where moving the linked mobile business and advertising unit reduces the risk associated with anchoring the business unit to one site. This flexibility allows the linked mobile business and advertising unit to be close to customer traffic. Perhaps during the summer the linked mobile business and advertising unit needs to be in a different place than during the winter. Or there might be special days, like spring breaks, causing heavy traffic on certain roads. Furthermore, locations like stadiums attract a large number of people for just a couple of hours.

The next is step 714, namely parking the linked mobile business and advertising unit in the desired place. Here the linked mobile business and advertising unit is not yet performing business transactions selling products or services. The unit has the option to change its form again to be parked and secured. The unit can be left alone overnight, and it has its protection against vandalism.

The next step is 716, namely setting the linked mobile business and advertising unit ready for business transactions. Once the linked mobile business and advertising unit arrived to a desired place it has the option to increases its volume, and can start operating right away. It doesn't necessarily require infrastructure like foundation, water connection, gas connection, or electricity connection. The unit is self sufficient in all these services. However, if the services exist, the linked mobile unit is ready to use them.

The linked mobile business and advertising unit has the option to allow handicapped people to work in it. Also, the option to allow handicapped people to perform the unit's expansion and retraction of volume. While the linked mobile business and advertising unit is operating, it can receive cars through a drive-thru window, and pedestrians on a serving window.

When it is operating, the linked mobile business and advertising unit performs step 722 receiving orders from customers. The order can be placed outside and far away from the linked mobile business and advertising unit, or right in front of it. To speed up the service, the linked mobile business and advertising unit can place a wireless, or wired, apparatus with a microphone and a menu, few yards away from the linked mobile business and advertising unit.

The linked mobile business and advertising unit has the option to recognize that a customer is getting close and it can display publicity and promotions for that customer. If the linked mobile business and advertising unit identifies the customer, it displays specific publicity and specific promotions that are of interest for that customer.

After receiving the order, the linked mobile business and advertising unit, on step 724 charges the customer for the order. To speed up the process there is an option to charge directly to a customer account. Customers may be identified immediately by their car's license plates, by a member card, or by radio frequency checking for a special device that customers should have on their car or carry with themselves.

After that, the linked mobile business and advertising unit, on step 726 delivers the order to the customer. It may use a special package to help drivers carry, in their cars, the products they just bought. And there might be another kind of package for pedestrians.

An operator, or a group of them, can execute the operation of the linked mobile business and advertising unit. But also, there is the option to have the linked mobile business and advertising unit working automatically with no people involved.

To complement its income, the linked mobile business and advertising unit sells publicity taking advantage of its attractive location close to customer traffic. The linked mobile business until goes through step 732 receiving the content of publicity for displaying. It can receive this content directly in the linked mobile business and advertising unit, or remotely from at least one control unit.

Then, the linked mobile business and advertising unit on step 734 receives the publicity orders for displaying the content of publicity. These orders instruct the linked mobile business and advertising unit which publicity content it will show, in which geographical zone, to which market segment, on which days, and at what time. It can use any of these attributes or a combination of them. It can receive these orders directly in the linked mobile business and advertising unit, or remotely from at least one control unit.

After receiving the orders, the linked mobile business and advertising unit, on step 736, displays the publicity according to the publicity orders. It can even display publicity after operating hours. The orders should include the instruction to turn on a publicity device, and to turn it off after a time. This will make an efficient use of energy.

Furthermore, the linked mobile business and advertising unit has the option to execute an additional step 738 (not shown) to evaluate the effect of publicity on sales. It can provide statistics and measurements about the behavior of sales comparing them before, during, and after publicity campaigns.

In order to have the linked mobile unit communicated, it performs two other steps. In step 742 it sends information to at least one control unit, and in step 744 it receives information from at least one control unit.

In step 742, the linked mobile business and advertising unit sends information such as its geographical position, its inventory levels, requests to search product in other units, requests for reordering products, history of transactions performed, requests for clean water, requests for gas, requests for electricity, requests for energy, requests for cleaning sewer tank, and requests for unit towing, among others. It can send any of these information sets, or a combination of them.

In step 744, the linked mobile business and advertising unit receives information such as publicity content remotely elaborated, publicity orders remotely elaborated, inventory level requests, customer information, and anticipation for unit towing, among others. It can receive any of these information sets, or a combination of them.

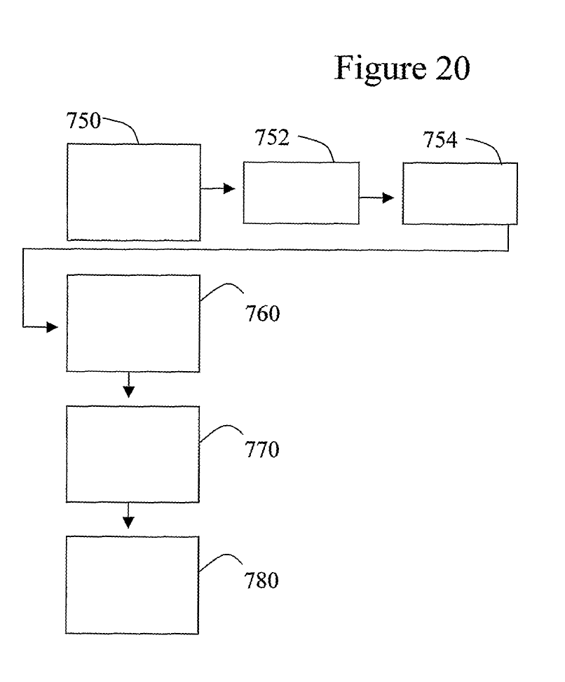

FIG. 20 is a block diagram illustrating the method for operating the chain of linked mobile business and advertising units.

Description of FIG. 20. The major steps for this method for operating the chain of linked mobile business and advertising units are 750 attending the plurality of linked mobile business and advertising units, and 760 providing information services to the plurality of linked mobile business. There is an additional optional step 770 selling space and time for publicity to be displayed on the plurality of linked mobile business and advertising units. Furthermore, there is another additional optional step 780 locating the plurality of linked mobile business and advertising units in geographical dispersed areas.

The step 750 attending the plurality of linked mobile business and advertising units is composed by steps 752 sending information to the plurality of linked mobile business and advertising units, and 754 receiving information from the plurality of linked mobile business and advertising units.

While this is a desired order of steps, there is no strict need to follow such order. Those of ordinary skill in the art having the benefit of the present disclosure will appreciate that many variations on the ordering of steps illustrated in FIG. 20 can be carried out.

Operation of FIG. 20. The control unit is responsible for forming chains with the linked mobile business and advertising units. It can also form subchains inside the chains. The control unit can serve one or more chains. There can be more than one control unit, and if there are more than one, they can interact with each other.

One chain of linked mobile business and advertising units can share the same brand. However, two different chains differentiated by their brand can share a geographical zone that is attractive for a third party looking to buy time and space on their publicity devices. Thus the control unit can form a logic chain for this goal.

The control unit, in step 752 sends information to the plurality of linked mobile business and advertising units. This information includes publicity content, publicity orders, inventory level requests, customer information, and anticipation for unit towing, among others. It can send any of these information sets, or a combination of them.

The control unit, in step 754 receives information from the plurality of linked mobile business and advertising units. This information includes geographical position, inventory levels, requests for product in stock search in other units, requests for products, transactions, requests for clean water, requests for gas, requests for electricity, requests for energy, requests for cleaning sewer tank, and requests for unit towing. It can receive any of these information sets or a combination of them.

The control unit, in step 760 provides information services to the plurality of the linked mobile business and advertising units. These information services include consolidating customer's transactions in a customer's account, administrative services, support for point of sale services, data warehousing services, business intelligence services, billing services, fees services, and commissions services.

It is thanks to this service that the linked mobile business and advertising units will identify a customer that has bought products or services from other linked mobile business and advertising units. Every linked mobile business and advertising unit share the same customer history, every unit knows the preferences of the customer, and can give a warmer touch during the sales process.

In the control unit, there is an additional optional step 770 for selling space and time for publicity to be displayed on the plurality of linked mobile business and advertising units. Third parties, companies, public relations agencies, marketing firms, and others can buy time and space to publish their ads on the publicity devices on the linked mobile business and advertising units. These firms might want to execute a publicity campaign in a geographical zone, or target a market segment or type of consumer, and they might want to show their ads only on certain days and just during specific hours. Within seconds of receiving this information in the control unit, the control unit can instruct the linked mobile business to start a publicity campaign. This process can be fully automated, can be manual, or can have a combination of both.

Furthermore, in the control unit, there is another additional optional step 780 for locating the plurality of linked mobile business and advertising units in geographical dispersed areas. This step includes activities such as finding the geographical position of at least one linked mobile business and advertising unit, suggesting new positions for the linked mobile business and advertising units, and issuing orders to move at least one linked mobile business and advertising unit from one point to another.

It is one of the functions of the control unit to make sure that the linked mobile business and advertising units are not saturating an area. While traditional franchisers delimit the areas where franchisees can install themselves, here a big difference is that the linked mobile business and advertising units are free to move to look for their customers. The control unit makes sure that a linked mobile unit is not moving out of a specific prearranged area, and that several linked mobile units are not saturating an area.

### CONCLUSION, ADVANTAGES, RAMIFICATIONS, AND SCOPE

From the description above, a number of advantages of my linked mobile business and advertising unit become evident:
(a) to provide a linked mobile business and advertising unit that has a communication link to at least one control unit, enabling a plurality of these business units to consolidate themselves in a chain, where the control unit has an information system that can control several attributes of the chain of business units, such as their geographical positions to avoid zone saturation, inventory levels to ensure product availability, a customer's account to ease customer's transactions in all business units, display of publicity to manage remotely-controlled publicity campaigns, a history of operations and transactions, and where the control unit can provide administrative and information services to the linked mobile business and advertising units;
(b) to provide a linked mobile business and advertising unit that complements the income it obtains from selling products and/or services with the income from selling publicity, where this publicity can be either controlled remotely or locally, and where the publicity can be displayed only on certain units which can be chosen by geographical zone, market segment, calendar, and/or time;
(c) to provide a linked mobile business and advertising unit that can measure the effect on sales of remotely controlled publicity, and that is able to classify such information by market segment, geographical zone, calendar, and time;
(d) to provide a linked mobile business and advertising unit that can turn on and off its publicity display devices remotely from a control unit to make an efficient use of energy, and to enable publicity campaigns with last minute changes to take advantage of these publicity display devices even when the linked mobile business and advertising unit isn't operating or when no operators are attending the unit;
(e) to provide a linked mobile business and advertising unit that detects the arrival of a customer, recognizes any established customer of the chain even when the customer has never bought anything in this specific unit, knows the customer's preferences, has the customer's history, displays customized publicity for the customer, and gives customized promotions to the customer;
(f) to provide a linked mobile business and advertising unit that can speed a cashier's waiting line by charging directly to a customer's account the products and/or services acquired without any bank approval process, where the customer's account is the same in a chain formed by a plurality of these linked mobile business and advertising units, and in any random location where these linked mobile business and advertising units operate;
(g) to provide a linked mobile business and advertising unit that can reduce many of its indirect costs by sharing these costs with other linked mobile business and advertising units, even when the other linked mobile business and advertising units are not necessarily selling the same products and/or services, and not necessarily part of the same corporation, company, franchise, or brand;
(h) to provide a linked mobile business and advertising unit that will be inexpensive to produce as a consequence of economies of scale, due to a large volume of similar manufactured units;
(i) to provide a linked mobile business and advertising unit that will allow having several permits prearranged, such as health, safety, and transportation permits, as a consequence of manufacturing similar models in large quantities;
(j) to provide a linked mobile business and advertising unit that provides inside of it training space and technology, so that employees working there can use non-operating time studying using a virtual university system, a distance learning model, a self didactic model, or any other current learning model; this advantage will attract and retain employees who can pursue a degree while they work;
(k) to provide a linked mobile business and advertising unit that its mobility reduces the risk associated to anchoring itself to one site;
(l) to provide a linked mobile business and advertising unit that rapidly installs and uninstalls, enabling it to approach temporary traffic such as events in stadiums, or to adapt to sudden changes in road traffic;
(m) to provide a linked mobile business and advertising unit that can be installed in one site for several months selling seasonal products and/or services, and then be easily uninstalled and moved or used for other products and/or services;
(n) to provide a linked mobile business and advertising unit that is self-sufficient in services such as water, drain, electricity, and energy, not requiring infrastructure such as foundation, and with the flexibility to use all these if they exist, thus being able to take advantage of many locations that otherwise couldn't be used, and being able to attract many landlords who are willing to lease their land to businesses that can move out rapidly leaving the used land intact;
(o) to provide a linked mobile business and advertising unit that has the flexibility to be self-sufficient in services such as water, electricity, gas, energy and drain, and with the ability to use these services if they exist, measuring their consumption; this ability will allow this business unit to acquire not only large amounts of these resources, but also, small amounts needed on the go, from small suppliers;
(p) to provide a linked mobile business and advertising unit that can vary its dimensions to comply with laws regulating transportation of mobile units on public roads, and to maximize its space while parked and in operation; this business unit has the option of performing this variation of dimensions so easily that in few minutes a single handicapped person can do it; and
(q) to provide a linked mobile business and advertising unit that can protect itself from vandalism, either when it's in operation or when it's not operating, enabling this business unit to operate at unprotected sites.

Accordingly, those of ordinary skill in the art will appreciate that the linked mobile business and advertising units of this invention can be grouped in many types of chains, and subchains. Also, in order to increase and decrease their volume they can grow in any dimension vertical, horizontal, and depth, or any combination of these dimensions.

Although various embodiments of the invention, and variations thereof, have been described herein, these should not be construed as limiting the scope of the invention but as merely providing illustrations of some of the presently preferred and alternative embodiments of this invention. People versed in the present art will readily appreciate that various alterations and modifications can be carried out. For example, the linked mobile business and advertising unit can have other shapes, different sizes, different colors, have its different parts connected in a different mode, use different materials, be made entirely or modularly, have different modes of operation, etc. . . . It is believed that various substitutions, alterations, and modifications to the specific embodiments described herein, including but not limited to those implementation variations specifically noted herein, may be made to the disclosed embodiment without departing from the spirit and scope of the invention, as defined in the appended claims, which follow.

That is, the scope of this invention should be determined by the appended claims and their legal equivalents, rather than by the examples given.

What I claim is:

1. A linked mobile business and advertising unit, comprising
a body carriage,
means for displaying publicity
means for selling items, and
means for linking to at least one control unit
whereby these elements cooperate to enable a business to be located close to customer outdoor traffic, performing business transactions, and displaying publicity, with remote coordination to increase the business efficiency as part of a chain.

2. The linked mobile business and advertising unit of claim 1, wherein said business can be selected from the group consisting of a store, a fast-food establishment, a restaurant, a catering stand, a laundry, a post office, a courier stand, a package delivery service center, a vaccination center, a wedding chapel, a tourist information center, a funeral service, a voting place, a catalog pickup and devolution center, a coupon exchange center, a tax service center, a cinema, a church, a car wash, a bank, a money transfer center, an office, a cyber cafe, an Internet access point, a training center, a medical service place, a ticket center, and a mechanical service garage.

3. The linked mobile business and advertising unit of claim 1, wherein said means for displaying publicity comprises
devices for showing publicity, and
means for controlling publicity.

4. The linked mobile business and advertising unit of claim 3, further including means for detecting a customer getting close to said linked mobile business and advertising unit.

5. The linked mobile business and advertising unit of claim 4, wherein said means for detecting a customer getting close to said linked mobile business and advertising unit can be selected from the group consisting of mechanical sensors, optical sensors, thermal sensors, sound sensors, and motion sensors.

6. The linked mobile business and advertising unit of claim 4, wherein said means for detecting a customer getting close to said linked mobile business can trigger an order that can be selected from the group consisting of an order to display publicity, and an order to give a promotion.

7. The linked mobile business and advertising unit of claim 3, wherein said devices for showing publicity can be selected from the group consisting of windows, exhibitors, panels, screens, liquid crystal displays, electronic papers, film substrate based displays, cathodic ray tubes CRT's, grids, speakers, light-bulb arrays, banners, television sets, flat TV sets, High Definition TV sets, mechanical machines, electric machines, and electronic machines.

8. The linked mobile business and advertising unit of claim 3, wherein said devices for showing publicity can be placed in a position selected from the group inside the linked mobile business and advertising unit, on the linked mobile business and advertising unit, and outside the linked mobile business and advertising unit.

9. The linked mobile business and advertising unit of claim 3, wherein said means for controlling publicity comprises
means for locally received publicity, and
means for remotely received publicity.

10. The linked mobile business and advertising unit of claim 9, wherein said means for controlling remotely received publicity comprises
means for receiving said remotely received publicity, and
means for instructing to use said remotely received publicity into said devices for showing publicity.

11. The linked mobile business and advertising unit of claim 3, wherein said means for controlling publicity can select publicity based on a criterion that can be selected from the group consisting of geographical zones, market segments, calendar, and time.

12. The linked mobile business and advertising unit of claim 3, wherein said means for controlling publicity can turn-on, and turn-off said devices for showing publicity to make an efficient use of energy.

13. The linked mobile business and advertising unit of claim 1, wherein said body carriage can be selected from the group consisting of a trailer, a semi trailer, a bus, a wagon, a car, a cart, and a modular structure.

14. The linked mobile business and advertising unit of claim 1, wherein said body carriage can be selected from the group consisting of a self propelled unit, and a non self propelled unit.

15. The linked mobile business and advertising unit of claim 1, wherein said body carriage comprises
means for expanding and retracting the structure of said body carriage resulting in different shapes, and
means for executing said expansion and said retraction which can be selected from the group consisting of automatic, semi-automatic, and manual.

16. The linked mobile business and advertising unit of claim 15, wherein said different shapes comprises
a transportable volume for moving said unit, and
an operational volume for selling products and services.

17. The linked mobile business and advertising unit of claim 16, further including a non operational volume for having the unit parked and secured.

18. The linked mobile business and advertising unit of claim 15, wherein said means for expanding and retracting the structure of the body carriage can be selected from the group consisting of telescopic devices, folding and unfolding devices, and accordion devices.

19. The linked mobile business and advertising unit of claim 15, where in said means for expanding and retracting the structure use devices that can be selected from the group consisting of mechanic, hydraulic, pneumatic, zipper, toothed wheels, pulleys, and ropes.

20. The linked mobile business and advertising unit of claim 15, wherein said means for expanding and retracting the structure of the body carriage can be implemented in a dimension that can be selected from the group consisting of horizontal, vertical, and depth.

21. The linked mobile business and advertising unit of claim 1, wherein said body carriage comprises
means for clean water services, and
means for used water services.

22. The linked mobile business and advertising unit of claim 21, wherein said means for clean water services, and said means for used water services use materials that can be selected from the group consisting of pipelines, tubes, bags, cisterns, tanks, and hoses.

23. The linked mobile business and advertising unit of claim 1, wherein said body carriage comprises means for energy services.

24. The linked mobile business and advertising unit of claim 23, wherein said energy can be selected from the group consisting of electricity, solar, gas, gasoline, hydrogen, diesel, bio-diesel, and hydrocarbons.

25. The linked mobile business and advertising unit of claim 1, wherein said items that can be sold can be selected from the group consisting of products and services.

26. The linked mobile business and advertising unit of claim 1, wherein said means for selling items comprises
means to receive orders for items,
means to charge for items, and
means to deliver items.

27. The linked mobile business and advertising unit of claim 26, where in said means to receive orders for items can be selected from the group consisting of drive thru windows, serving windows, drive in stations, drive inside stations, self service stations, points of sales, service counters, screens, displays, menus, phones, Internet pages, wired speakers, wired microphones, wireless speakers, and wireless microphones.

28. The linked mobile business and advertising unit of claim 26, wherein said means to charge for items can be selected from the group of drive thru windows, serving windows, drive in stations, drive inside stations, self service stations, service counters, cashiers machines, credit card machines, debit card machines, member card machines, wireless apparatus to charge to a customer account without using cash or cards at the moment of the transaction, and radio frequency apparatus to charge to a customer account without using cash or cards at the moment of the transaction.

29. The linked mobile business and advertising unit of claim 26, wherein said means to deliver items can be selected from the group consisting of drive thru windows, serving windows, drive in stations, drive inside stations, self service stations, service counters, and delivery stations.

30. The linked mobile business and advertising unit of claim 26, where said means to receive orders for items, said means to charge for items, and said means to deliver items can be positioned in a place that can be selected from the group consisting of inside said mobile business unit, outside said mobile business unit, and inside and outside said mobile business unit.

31. The linked mobile business and advertising unit of claim 1, wherein said means for linking to at least one control unit comprises
an antenna, and
means for communications.

32. The linked mobile business and advertising unit of claim 31, where in said means for communications use a transmission technology that can be selected from the group consisting of AM radio frequency, FM radio frequency, radio frequency, cellular, satellite, infrared, ultrasound, and digital.

33. The linked mobile business and advertising unit of claim 1, further including means for linking to at least one other linked mobile business and advertising unit.

34. The linked mobile business and advertising unit of claim 1, further including means for training and educating people who work inside said linked mobile business and advertising unit.

35. The linked mobile business and advertising unit of claim 34, wherein said means for training and educating people who work inside said linked mobile business and advertising unit can be selected from the group consisting of a computer, an Internet connection, and a desk.

36. The linked mobile business and advertising unit of claim 1, further including means for a computer controlled operation of the mobile business unit where no people is required to operate said linked mobile business and advertising unit.

37. A chain of linked mobile business and advertising units comprising,
a plurality of linked mobile business and advertising units, and
at least one control unit.

38. The chain of linked mobile business and advertising units of claim 37, wherein said linked mobile business and advertising unit comprises
a body carriage,
means for displaying publicity,
means for selling items, and
means for linking to at least one control unit.

39. The chain of linked mobile business and advertising units of claim 37, wherein said control unit comprises
means for communicating with a plurality of linked mobile business and advertising units,
and means for controlling the linked mobile business and advertising units.

40. The chain of linked mobile business and advertising units of claim 39, wherein said means that the control unit has for controlling the linked mobile business and advertising units can be selected from the group consisting of computer control, and manual control.

41. The chain of linked mobile business and advertising units of claim 39, wherein said means that the control unit has for controlling the linked mobile business and advertising units further including means for communicating with customers acquiring publicity time and space on the plurality of linked mobile business and advertising units.

42. The chain of linked mobile business and advertising units of claim 39, wherein said means that the control unit has for controlling the linked mobile business and advertising units further including means for charging and controlling customer accounts.

43. The chain of linked mobile business and advertising units of claim 42, wherein said means for charging customer accounts can be selected from the group consisting of charging a credit card, charging a bank account, charging an account in a financial institution, charging a private personal account, charging a corporate account, charging a private corporate account.

44. The chain of linked mobile business and advertising units of claim 39, wherein said means for controlling the linked mobile business and advertising units can control activities that can be selected from the group consisting of checking inventory levels, ordering refill of products to ensure product availability, consolidate customers transactions in one account for each customer, consolidate transaction history, order refills of clean water, order refills of gas, order refills of electricity, order refills of energy, order cleaning of sewer tank, order towing of a unit, check geographical location of a unit, and check geographical dispersion of units.

45. The chain of linked mobile business and advertising units of claim 37, wherein said chain system can be divided in smaller chains also called subchains.

46. A method of operating a linked mobile business and advertising unit comprising the steps:
positioning said linked mobile business and advertising unit in a place close to customer traffic,
performing business transactions,
displaying publicity,
and communicating to at least one control unit.

47. The method of operating the linked mobile business and advertising unit of claim 46, wherein the step of positioning said linked mobile business and advertising unit in a place close to customer traffic comprises the steps:
moving said linked mobile business and advertising unit to a desired place,
parking said linked mobile business and advertising unit in said desired place, and
setting said linked mobile business and advertising unit ready for business transactions.

48. The method of operating the linked mobile business and advertising unit of claim 46, wherein the step of performing business transactions comprises the steps:
receiving an order from the customer,
charging the order to the customer,
delivering the order to the customer.

49. The method of operating the linked mobile business and advertising unit of claim 46, wherein the step of displaying publicity comprises the steps:
receiving the content of publicity for displaying,
receiving the publicity orders for displaying said content of publicity,
displaying said publicity according to said publicity orders.

50. The method of operating the linked mobile business and advertising unit of claim 49, wherein the step of displaying publicity further comprising the step of evaluating the effect of publicity on sales.

51. The method of operating the linked mobile business and advertising unit of claim 46, wherein the step of communicating to at least one control unit comprises the steps:
sending information to at least one control unit, and
receiving information from at least one control unit.

52. The method of operating the linked mobile business and advertising unit of claim 51, wherein the step of sending information to at least one control unit includes information that can be selected from the group consisting of geographical position, inventory levels, requests to search product in stock in other units, requests for products, transactions, requests for clean water, requests for gas, requests for electricity, requests for energy, requests for cleaning sewer tank, and requests for unit towing.

53. The method of operating the linked mobile business and advertising unit of claim 51, wherein the step of receiving information from at least one control unit includes information that can be selected from the group consisting of publicity content remotely elaborated, publicity orders remotely elaborated, inventory level requests, customer information, and anticipation for unit towing.

54. A method of operating a chain having at least one control unit, and a plurality of linked mobile business and advertising units, the method comprising the steps:
attending the plurality of linked mobile business and advertising units, and
providing information services to the plurality of linked mobile business and advertising units.

55. The method of operating a chain of claim 54, further comprising the step of:
selling space and time for publicity to be displayed on the plurality of linked mobile business units.

56. The method of operating a chain of claim 54, further comprising the step of:
locating the plurality of linked mobile business and advertising units in geographical dispersed areas.

57. The method of operating a chain of claim 54, wherein the step of attending the plurality of linked mobile business and advertising units comprises the steps:
sending information to the plurality of linked mobile business and advertising units, and
receiving information from the plurality of linked mobile business and advertising units.

58. The method of operating a chain of claim 57, wherein the step of sending information to the plurality of linked mobile business and advertising units includes information that can be selected from the group consisting of publicity content, publicity orders, inventory level requests, customer information, and anticipation for unit towing.

59. The method of operating a chain of claim 57, wherein the step of receiving information from the plurality of linked mobile business and advertising units includes information that can be selected from the group consisting of geographical position, inventory levels, requests for product in stock search in other units, requests for products, transactions, requests for clean water, requests for gas, requests for electricity, requests for energy, requests for cleaning sewer tank, and requests for unit towing.

60. The method of operating a chain of claim 54, wherein the step of providing information services to the plurality of linked mobile business and advertising units includes information services that can be selected from the group consisting of consolidating customer's transactions in a customer's account, administrative services, point of sale services, data warehousing services, business intelligence services, billing services, fees services, and commissions services.

61. The method of operating a chain of claim 55, wherein the step of selling space and time for publicity to be displayed on the plurality of linked mobile business and advertising units includes activities that can be selected from the group consisting of man controlled, computer controlled, and a combination of manual and computer controlled.

62. The method of operating a chain of claim 56, wherein the step of locating the plurality of linked mobile business and advertising units in geographical dispersed areas includes activities that can be selected from the group of finding the geographical position of at least one linked mobile business and advertising unit, suggesting new positions for the linked mobile business and advertising units, and issuing orders to move at least one linked mobile business and advertising unit from one point to another.
